(19) United States
(12) Patent Application Publication
(10) Pub. No.: US 2026/0244480 A1
(43) Pub. Date: Aug. 20, 2026

(54) System and Method for Executing Computational on Computational Processing Units

(71) Applicant: CentML AI Inc., Toronto (CA)

(72) Inventors: Yaoyao DING, Toronto (CA); Bohan HOU, Pittsburgh, PA (US); Xiao ZHANG, Toronto (CA); Allan LIN, Toronto (CA); Hao YU, Sunnyvale, CA (US); Yida WANG, Palo Alto, CA (US); Gennady PEKHIMENKO, Toronto (CA)

(73) Assignee: CentML AI Inc., Toronto (CA)

(21) Appl. No.: 19/543,943

(22) Filed: Feb. 19, 2026

Related U.S. Application Data
(60) Provisional application No. 63/760,165, filed on Feb. 19, 2025.

(51) Int. Cl. G06F 9/455; G06T 1/20

(52) U.S. Cl. CPC G06F 9/45558; G06T 1/20; G06F 2009/4557

(57) ABSTRACT

A system and method for executing computational workloads on a computational processing unit is provided. The method includes deploying a virtual machine (VM) by abstracting program behavior of the computational processing unit into instructions associated with groups of execution threads and providing a data layout system that defines distribution of data elements across threads within the groups of execution threads. The method further includes executing computational workloads by processing data elements distributed according to the data layout system.

### CROSS-REFERENCE TO RELATED APPLICATION(S)

This application claims priority to U.S. Provisional Patent Application No. 63/760,165 filed on Feb. 19, 2025, the entire contents of which are incorporated herein by reference.

### TECHNICAL FIELD

The following generally relates to executing computational workloads, e.g., large language model (LLM) inference or serving, on computational processing units, such as general purpose graphics processing unit (GPGPUs), and more particularly to a system and method for enabling computation using flexible data representations, including arbitrary low-precision data types, on such computational processing units.

### BACKGROUND

Modern computational workloads increasingly rely on high-performance processing systems to execute data intensive operations efficiently. Such workloads arise across a wide range of application domains, including machine learning, data analytics, scientific computing, and other compute accelerated tasks that involve large volumes of data and complex numerical operations. As these workloads grow in scale and complexity, they place increasing demands on processing resources, memory bandwidth, and energy efficiency. Improving the execution efficiency of such computational workloads has therefore become an important objective in modern computing systems.

One prominent class of such computational workloads includes large language models (LLMs), which has revolutionized natural language processing tasks by enabling advanced capabilities in areas such as text generation [6], summarization [24], translation [49], and conversational artificial intelligence (AI) [32]. However, serving LLMs poses substantial computational challenges due to the large model sizes and high computational demands. Efficient LLM serving typically demands innovative computational strategies to manage latency and power consumption constraints. As such, optimizing LLM inference has become a priority in both industry and research to reduce latency and increase throughput of LLM serving.

Quantization [9, 15, 23] has emerged as a leading method for enhancing the efficiency of LLM serving. By reducing the bit width of model parameters and activations, quantization reduces weight storage, dynamic random access memory (DRAM) bandwidth usage and allows LLMs to store/load data and perform computations in lower precision, thereby achieving faster computations. For instance, A16W4 quantization (16-bit activation and 4-bit weight) could reduce the DRAM consumption and throughput by four times compared with A16W16 scheme, thus reducing the time to generate a token by about four times [47]. However, generating efficient quantization kernels with arbitrary bit widths and across data types (e.g., integer and floating numbers) remains an open problem on modern graphics processing units (GPUs) to adopt more quantization schemes.

Current approaches to generating computation kernels mainly fall into two categories: manually written kernels [9, 27,28] and compiler-generated kernels [7,10,14,16,41,47,56]. Manually written kernels are often highly optimized for specific hardware, offering performance advantages on targeted architectures. However, they are error-prone, time-consuming to develop, and lack extensibility, making them difficult to adapt to new hardware, evolving quantization methods and new low-precision data types. For example, QuantLLM's [50] manually written kernels only support floating-point quantization with 5 or 6 bits data types and do not support sub-channel quantization granularity.

To address these limitations, compiler-based approaches [7, 10, 14, 16, 41, 47, 56] have been proposed to automate kernel generation, among which Triton [41] and Ladder [47] are able to generate low-precision kernels. Triton [41] simplifies the general-purpose computing on GPU (GPGPU) programming by introducing the tile programming model. A Triton program defines the computation of a thread block for tensor tiles. However, Triton does not provide support for low-precision data types. It requires the users to implement low level bitwise operations to support low-precision integer types and there is no way to support low-precision floating numbers. Additionally, Triton does not expose the full GPU memory hierarchy, thereby limiting optimization opportunities for low-precision LLM inference. This limitation further prevents users from exercising fine-grained control over data flow across the GPU system. Meanwhile, Ladder [47] extends the scheduling system of an optimizing compiler called TVM [7, 14] to support low-precision computation. However, Ladder only has efficient support for data types with bit widths that are powers of two. Moreover, it is found that its extended primitives are not able to express some important optimizations such as software pipelining [18] to achieve higher GPU utilization, resulting in sub-optimal performance for batch size larger than one in the LLM decoding.

### SUMMARY

LLM serving has become important for deploying artificial intelligence (AI) powered applications, yet it entails immense computational demands, for example, in terms of memory bandwidth and floating-point computational throughput. Low precision computation has emerged as a key technique to improve efficiency while reducing resource consumption. Similar demands may be found in other computational applications such as general machine learning workloads, stable diffusion, convolution neural networks, and to program kernels that are used by scientific computing in general that requires GPU acceleration. To address the need for efficient serving, low-precision computation has emerged as a vital approach to accelerate processing while conserving resources. Prior approaches to generating low precision kernels are limited to weight bit widths that are powers of two and may exhibit suboptimal performance because of high-level GPU programming abstractions. These abstractions limit critical optimizations, such as fine-grained control over data placement in registers and better memory access patterns, which are needed for low-precision computations.

The following describes a virtual machine (VM) and a corresponding programming structure, referred to as Tilus, tailored for GPGPU computing that supports low-precision data types with arbitrary bit widths, e.g., from 1 to 8, without sacrificing the programmability of GPUs. In an embodiment, the VM (and Tilus) features a thread-block-level programming model with a hierarchical memory space, a novel algebraic layout system, and extensive support for diverse low-precision data types. VM programs are compiled into efficient GPU programs through automatic vectorization and instruction selection. Experimental data shows that the proposed VM (and/or the corresponding programming structure, Tilus) efficiently supports a full spectrum of low-precision data types, and can achieve better performance than existing low-precision kernels. Compared to existing compilers, such as Triton, Ladder or hand-crafted kernels such as QuantLLM and Marlin. Tilus achieves performance improvements of 1.75×, 2.61×, 1.29× and 1.03×, respectively.

In one aspect, a method for executing computational workloads on a computational processing unit is provided. The method includes deploying a virtual machine (VM) by abstracting program behavior of the computational processing unit into instructions associated with groups of execution threads and providing a data layout system that defines distribution of data elements across threads within the groups of execution threads. The method further includes executing computational workloads by processing data elements distributed according to the data layout system.

In another aspect, a computer readable medium is provided. The computer readable medium storing computer executable instructions for performing the method described above for executing computational workloads on a computational processing unit.

In another aspect, a computer system for executing computational workloads on a computational processing unit is provided. Computer system includes a processor configured to deploy a virtual machine (VM) by abstracting program behavior of the computational processing unit into instructions associated with groups of execution threads and providing a data layout system that defines distribution of data elements across threads within the groups of execution threads. The processor is further configured to execute computational workloads by processing data elements distributed according to the data layout system.

In an example implementation, the computational workload includes one or more of a large language model (LLM) inference or LLM serving or at least one general machine learning workload.

In an example implementation, executing the computational workloads further includes automatic vectorization of the processed data elements.

In an example implementation, the method includes enabling access to memory spaces associated with the computational processing unit to enable memory control for executing computational workloads.

In an example implementation, enabling access to memory spaces further includes defining a mapping between a logical index of a data element and a location of the corresponding data element within one or more memory scopes of the memory spaces.

In an example implementation, executing computational workloads includes reinterpreting the data elements distributed according to the data layout system into a data type different from an original data type of the data elements.

In an example implementation, the computational processing unit includes one or more graphics processing unit (GPU) and the groups of execution threads correspond to thread-blocks associated with the GPU, and the program behavior of the GPU is abstracted into a thread-block-level instructions model.

In an example implementation, the data layout system is an algebraic layout system.

In an example implementation, the data elements are represented using variable bit widths.

In an example implementation, the data elements are represented using arbitrary low-precision bit widths ranging from 1 to 8 bit widths.

In an example implementation, the data elements include signed integer, unsigned integer and floating point data types.

### BRIEF DESCRIPTION OF THE DRAWINGS

Embodiments will now be described with reference to the appended drawings wherein:

FIG. 1 illustrates an example computing environment in which an example virtual machine (VM) is deployed.

FIG. 2 illustrates an example of a computing device utilized to implement the VM.

FIGS. 3A, 3B, and 3C illustrate a weight loading pipeline of Triton, Ladder and the VM of the present disclosure.

FIG. 4A illustrates an example VM program of low-precision Matmul.

FIG. 4B illustrates an example data flow of the low-precision Matmul.

FIG. 4C illustrates an example register tensor reinterpretation.

FIG. 5 shows an example of a layout of an instruction operand.

FIG. 6 illustrates examples of two kinds of primitive data layouts used in the VM of the present disclosure.

FIG. 7 illustrates layout composition examples.

FIG. 8 illustrates an example unified layout representation.

FIG. 9 illustrates a VM program structure.

FIG. 10 provides an illustration of low-precision data types.

FIGS. 11A, 11B, and 11C illustrate the storage of low-precision numbers, an example implementation for loading, and an example implementation for storing, respectively.

FIG. 12 illustrates an example of a program to rearrange a tensor with a data type used in the change layout step in FIG. 4B.

FIG. 13 illustrates the speedup of different low-precision kernels.

FIG. 14 illustrates the speedup of quantized matrix multiplication compared against cuBLAS FP16 kernel.

FIG. 15 illustrates end-to-end performance across representative LLMs.

FIG. 16 illustrates end-to-end performance across different hardware.

FIG. 17 illustrates the speedup of quantized matmuls across different batch sizes from both prefill and decode stages.

FIG. 18 illustrates GPU utilization for different kernels by detailing the throughput utilization of memory units and pipeline utilization of computation units.

FIG. 19 illustrates an optimized matrix multiplication with proper tile sizes and software pipeline optimization.

### DETAILED DESCRIPTION

In LLM serving, inference includes two stages: prefill and decode. In the prefill stage, the model processes the initial input sequence to build a contextual understanding, while in the decode stage, it iteratively generates each output token, relying on the encoded context and prior tokens. Key components in LLMs include multi-head attention, feed-forward networks, and layer normalization [45]. Matrix multiplications (matmul), the dominant operation in these layers, account for most of the latency in LLM inference, highlighting the need for optimization in serving environments [8]. Quantization [9, 15] improves the efficiency by representing model weights and activations with lower-precision formats, such as 8-bit or 4-bit integers (i.e., int8 and int4), reducing computation and memory demands. By selecting appropriate lower-precision data types, quantization reduces the memory footprint while preserving model accuracy. While 4-bit quantization provides significant computational savings, state of the art methods still suffer from accuracy degradation. Increasing precision to 5-bit, 6-bit, or 7-bit quantization can help preserve accuracy while maintaining efficiency, but these bit widths lack optimized GPU support, thereby limiting their adoption. Current GPU architectures and software stacks primarily optimize for power-of-two bit widths (e.g., 4-bit and 8-bit), making arbitrary bit widths computationally inefficient. However, demand for flexible quantization is growing, as 4-bit can be too aggressive for some models while 8-bit wastes resources. Supporting a broader spectrum of bit widths enables better accuracy-efficiency tradeoffs in LLM serving, driving the need for new kernel generation techniques that can efficiently handle non-standard low precision formats (e.g., those with 3, 5, 6, 7 bit widths) on modern GPUs.

In an example implementation, General-Purpose GPU (GPGPU) programming enables parallel computation by organizing tasks within a structured execution and memory hierarchy [26]. The execution hierarchy begins with the thread, the smallest unit of execution, which performs instructions independently with its own registers and local memory. Threads can be grouped into a number of groups of execution threads, such as thread blocks, which enable data sharing through shared memory and support synchronized execution. For example, a grid encompasses multiple independent groups of execution threads, e.g., thread blocks, enabling large-scale parallelism by organizing thousands or millions of threads. The GPU memory hierarchy can include registers, shared memory, and global memory. Registers provide fast and thread-private storage. Shared memory is accessible by all threads within a group of execution threads, i.e., a thread block, and is faster than global memory. Global memory is accessible across the entire grid, with high latency, and used for large and persistent data storage during kernel execution. This structure allows for highly efficient parallel execution by leveraging both the execution and memory hierarchies.

GPGPU programming involves various languages and compilers that balance hardware abstraction with control. Low-level languages such as SASS [31] and third generation Compute DNA (CDNA3) [3] offer direct hardware access for fine-grained optimizations but require deep architectural knowledge. Slightly higher in abstraction, NVIDIA's PTX [30] serves as an intermediate representation, linking high-level languages such as CUDA [29] to GPU-specific instructions while preserving optimization flexibility.

High-level languages like CUDA [29] and HIP [4] simplify programming by extending C programming language, while OpenCL [40] provides cross-platform compatibility at the cost of increased verbosity. Despite these languages, GPGPU programming remains complex. It may be constrained by hardware-specific memory and computation hierarchies and requires workload-specific optimizations.

To address these challenges, researchers have introduced higher-level languages and compilers, classified into two categories: tile-oriented compilers, which simplify programming through abstractions beyond CUDA [29], and schedule-oriented compilers, which optimize computation hardware mappings via declarative scheduling primitives.

Tile-oriented compilers, such as Graphene, Hidet, and Triton enable programmers to write kernels directly, offering abstractions, such as tile-level tasks/element distribution, to simplify the process. Triton [41], for instance, introduces the tile programming model, where thread block behavior is defined programmatically, and tiles replace scalars as the basic data type. This approach combines programming simplicity with high performance kernel generation, making Triton widely adopted. However, Triton lacks native support for low-precision data types like uint4. Handling these types requires manually unpacking sub-byte data (e.g., uint4) from larger storage types (e.g., uint32) [17]. Additionally, Triton does not expose the GPU memory hierarchy, limiting programmers' control over data loading and memory scope usage, which complicates performance optimization for low-precision kernels. These limitations result in inefficient low-precision kernel execution.

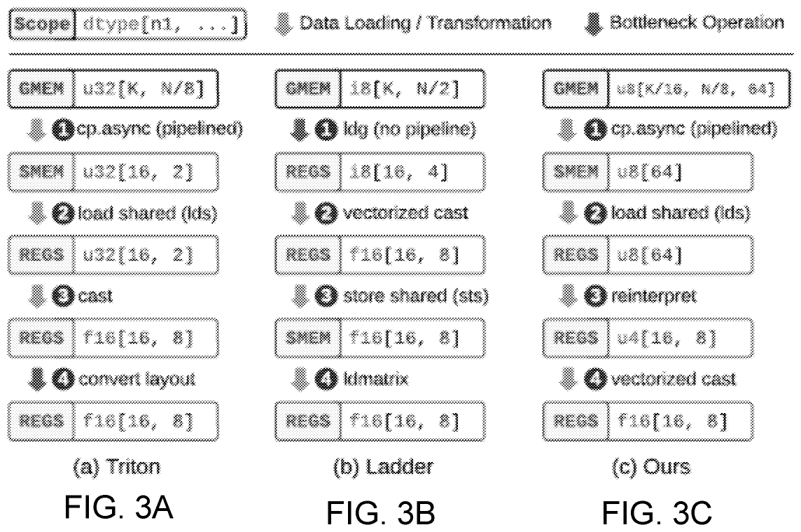

FIG. 3A illustrates the inefficiencies in Triton-generated low-precision kernels, using a uint4 weight loading pipeline as an example. The process includes four steps: (1) weights are asynchronously copied from global memory to shared memory using pipelined cp.async instructions [18]; (2) shared memory data is loaded into registers; (3) unpacking and casting operations are performed; and (4) the register tensor layout is converted to meet the requirements of tensor core instructions. Among these, step (4) is found to be a major bottleneck due to the reliance on shared memory for layout conversion, which incurs significantly higher latency compared with registers.

Schedule-oriented compilers decouple computation from scheduling to optimize the computation-to-hardware mappings. Halide [34] pioneered this approach, which was later extended by TVM [7] and subsequent works [14, 18, 36, 46, 47, 56, 57] in the domain of deep learning. Among them, Ladder [47] is the first one to support low-precision computation by introducing dedicated primitives to pack low-precision data (e.g., 4-bit integers) into larger types (e.g., 8-bit integers).

However, Ladder [47] has two observed limitations. First, Ladder may not be able to handle non-power-of-two bit widths efficiently due to type-level packing, restricting supported low-precision data types. Second, Ladder's primitive style scheduling prevents optimizations such as software pipelining [18], resulting in suboptimal performance.

FIG. 3B illustrates the weight loading process in Ladder-generated low-precision kernels. This process includes (1) loading weights from global memory to registers without pipelining; (2) vectorized casting; (3) storing the cast results in shared memory; and finally (4) using the Idmatrix instruction to load weights from shared memory to registers for subsequent tensor core operations. The lack of pipelining between weight loading and computation can significantly hinder performance.

In an embodiment, the aforementioned limitations may be addressed by providing a general purpose graphical processing unit (GPGPU) virtual machine (VM) tailored for low-precision serving of computational entities and applications, such as LLMs, which may be referred to herein as the “system” or, alternatively, VM for ease of reference. In an example implementation, a tile-level GPGPU programming structure backed by the virtual machine (VM) of the present disclosure can be implemented. In an embodiment, the VM can abstract GPU program behavior into thread group level (e.g., thread-block-level) instructions. Further, the VM can simplify GPGPU programming while exposing hierarchical memory spaces of modern GPUs to enable fine-grained manipulation of sub-tensors in on-chip memory. This dual approach can facilitate efficient handling for arbitrary-precision data types and reduce the complexity of GPU programming. In an embodiment, to achieve this goal, the GPGPU virtual machine can be provided with:
(1) a data layout system, such as an algebraic layout system, that specifies how data elements (e.g., tensor elements) within a tile are distributed across threads in a group of execution threads (i.e., a thread block). With such a layout for the system, one can freely reinterpret the low precision tile in registers as a tile with standard data types or vice versa for efficient processing. Further, the layout specification provides a unified way to represent the storage of tile elements among different threads, making it possible to expose the registers to the kernel developers and simplify the code generation during compilation.
(2) an execution thread group level (e.g., thread-block-level) programming model with fine-grained memory management across different levels of GPU memory hierarchy, enabling enhanced control over data movement, placement and computation; and comprehensive support for:
(3) arbitrary low-precision data types (signed integers, unsigned integers, and floating-point numbers with bit widths from 1 to 8).

Extensive experiments show that the VM can extend the spectrum of efficient low-precision kernels to support arbitrary bit widths (from 1-8) and data type kinds (e.g., integer and floating-point numbers). At the same time, the VM outperforms the state-of-the-art compilers, such as Triton [41], Ladder [47], and hand-crafted kernels from QuantLLM [50] and Marlin by 1.75×, 2.61×, 1.29×, and 1.03×, respectively.

In an example embodiment, the present disclosure provides:
a) a GPGPU VM to model the GPU programming with dedicated support for low-precision computation, addressing the bit-width coverage and performance gap in conventional approaches.
b) Inside the VM, a novel data layout system, a thread-group-level programming model with hierarchical memory space, and that supports low-precision data types with arbitrary bit widths from 1 to 8, for example.

Experiments show that the VM can be programmed to generate a full spectrum of highly efficient low-precision kernels that outperforms the state of the art approaches on their supported low precision data types by up to 2.6 times, while enabling efficient quantization across arbitrary low-precision data types.

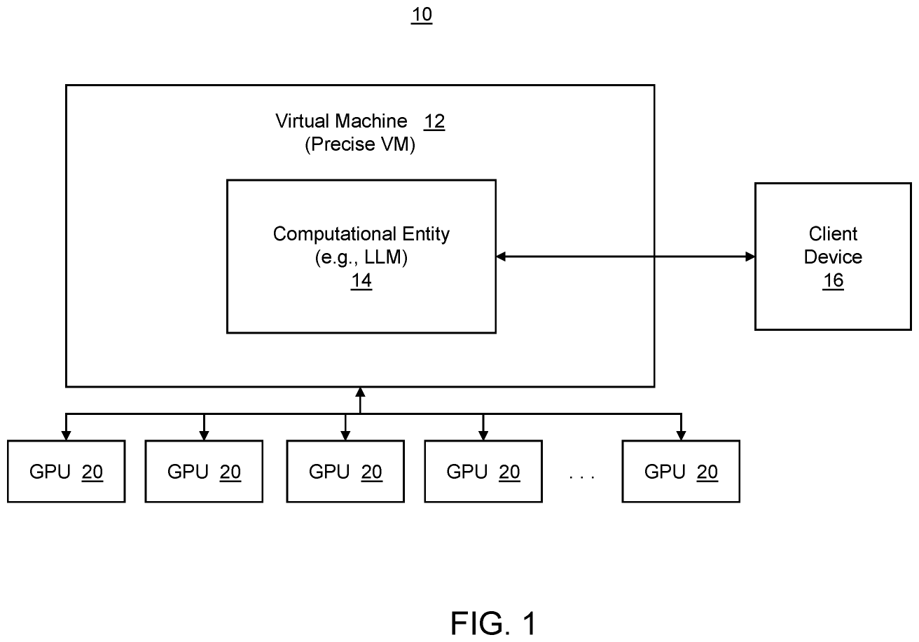

Referring now to FIG. 1, an example of a computing environment 10 is shown in which the present system, method, processes and optimizations may be deployed. It can be appreciated that the computing environment 10 is just one example and the methods described herein may be applied to a wide range of computational workloads associated with computational entities executed using virtual machines. Such computational entities may include applications or models, for example, LLMs, general machine learning workloads, stable diffusion based models, convolution neural networks, as well as computational program kernels that are used in scientific computing in general that require accelerated execution, such as GPU acceleration, etc. As such, while examples shown herein may reference LLMs, the disclosed principles can be applied to executing computational workloads for diverse computational entities using VMs across a variety of application domains and processing environments.

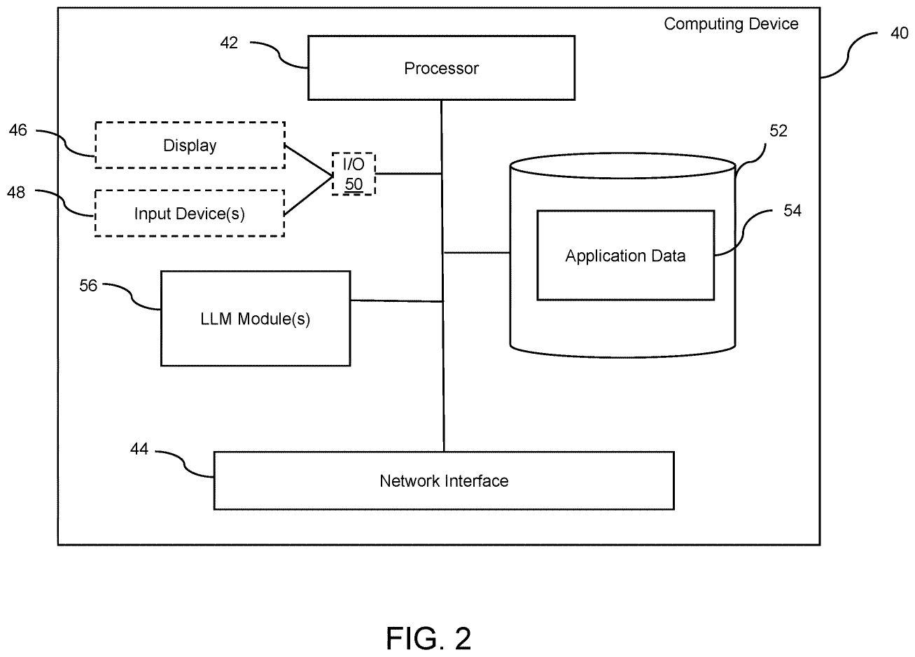

In an example implementation, the computing environment 10 includes a virtual machine (VM) 12. The VM 12 virtualizes the operations of a number of computational processing units, shown as GPUs 20 in the illustrated example, to perform computational workloads, such as the GPGPU operations. The VM 12 does so to serve a computational entity 14 (e.g., LLM). The entity 14 is served for a particular purpose, e.g., for LLMs, to respond to prompts in a chat application, and may be interacted with by a client device 16, which may correspond to any suitable computing device 40, exemplified in, for example, FIG. 2. It can be appreciated that while FIG. 1 and the examples herein refer to applying the presently described principles to GPUs, the principles may also be applied to support execution of computational workloads on any other computational processing units, such as central processing units (CPUs), tensor processing units (TPUs), etc.

The VM 12 and its hosted computational entity 14 may be accessed by the computing device 16 over a communication network (not shown). Such communication network(s) may include the Internet, accessed via, for example, a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet). The network(s) may also include other types of connections such as those coupled to a data center and high-bandwidth connections such as Infiniband, AWS EFA, nvlink, PCIe, etc.

FIG. 2 shows an example of a computing device 40, e.g., from a set of one or more computing devices 40, which may be utilized by any one or more of the entities shown in FIG. 1, for example, a server or platform used to provide the VM 12 serving the entity 14 and/or the GPU(s) 20, client device 16, or other computing devices 40 operating within the computing environment 12. Similarly, the computing device 40 in FIG. 2 may provide an example of a device on which downstream application(s)—not shown, may be deployed.

In this example, the computing device 40 includes one or more processors 42 (e.g., a microprocessor, microcontroller, embedded processor, digital signal processor (DSP), central processing unit (CPU), media processor, graphics processing unit (GPU), accelerators such as TPUs and neural processing units (NPUs), or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as local area network (LAN), wide area network (WAN), personal area network (PAN), cellular, and/or via short-range communications protocols such as Bluetooth, WiFi, near field communication (NFC), infrared (IR), etc. As noted above, the communication connections described herein may also include other types of connections such as those coupled to a data center and high-bandwidth connections such as Infiniband, Amazon Web service (AWS) elastic fabric adapter (EFA), nvlink, peripheral component interconnect express (PCIe), etc.

For ease of illustration, in this and examples described below, the computational entity 14 may be referred to interchangeably by its example application, such as LLM 14. In example implementations, the computing device(s) 40 may also include one or more LLM modules 56 for serving or interacting with the LLM 14. The computing device 40 may include a data store 52, and client application data 54. The data store 52 may represent a database or library or other computer-readable medium configured to store data and permit retrieval of data by the computing device 40. The data store 52 may be read-only or may permit modifications to the data. The data store 52 may also store both read-only and write accessible data in the same memory allocation. In this example, the data store 52 stores the application data 54 for any application and/or the LLM module(s) 56 utilized by and configured to be executed by the computing device 40 for a particular role or purpose.

While not delineated in FIG. 2, the computing device(s) 40 include(s) at least one memory or memory device that can include a tangible and non-transitory computer-readable medium and/or volatile memory such as random access memory (RAM), having stored therein computer programs, sets of instructions, code, or data to be executed by processor(s) 42. The processor(s) 42 and network interface(s) 44 are connected to each other via a data bus or other communication backbone to enable components of the computing device 40 to operate together as described herein. FIG. 2 illustrates examples of modules and applications stored in memory on the computing device 40 and executed by the processor(s) 42.

It can be appreciated that any of the modules and applications shown in FIG. 2 may be hosted externally and may be available to the computing device 40, e.g., via a network interface 44. The data store 52 may additionally store one or more software functions or routines in a cache or in other types of memory.

As shown in FIG. 2, the computing device(s) 40 may, optionally (e.g., when configured as a personal electronic device such as a smartphone or tablet), include a display 46 and one or more input device(s) 48 that may be utilized via an input/output (I/O) module 50. In some examples, such components may be omitted, such as, when the computing device 40 does not interact with a user.

While examples referred to herein may refer to a single display 46 for ease of illustration, the principles discussed herein may also be applied to multiple displays 46, e.g., to view portions of user interfaces (UIs) rendered by or with an application on separate side-by-side screens. That is, any reference to a display 46 may include any one or more displays 46 or screens providing similar visual functions. The application receives one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user interacting with the computing environment 10, e.g., by operating the computing device 40.

The system described herein provides a VM 12 and a corresponding programming structure and framework (hereinafter referred to as “Tilus”) specifically designed to overcome the challenges of the conventional systems by providing fine-grained control over shared memory and registers, making it possible to program efficient low precision deep learning kernels. The VM 12 supports efficient weight loading for low-precision data types with arbitrary bit widths ranging from 1 to 8. FIG. 3C shows the example VM's weight loading pipeline (taking uint4 as an example). The pipeline begins with (1) a pipelined asynchronous memory copy from global memory to shared memory, followed by (2) loading the register tensor from shared memory. Next, at (3), reinterpret the register tensor into a different data type and layout without additional computational cost, and then (4) perform vectorized casting. This pipeline achieves improved efficiency compared to the other methods and pipelines shown in FIGS. 3A to 3C, as it eliminates layout conversion (unlike Triton [41]) and incorporates pipelining (unlike Ladder [47]). Furthermore, this approach is versatile, and seamlessly supports low-precision data types with arbitrary bit widths ranging from 1 to 8.

Several advantageous concepts form the bases for the present configuration, to achieve such efficient weight loading. In an example implementation, the VM 12 is a GPGPU VM design to allow programming of the GPU with high flexibility, thereby enabling programmers to implement and fine-tune optimizations beyond standard loop transformations. Unlike schedule-oriented compilers that abstract optimization through declarative primitives, a procedure-oriented approach can provide more granular control over the programming process. For example, by abstracting GPU functionalities, such as memory loading and computation, into instructions, it becomes easier to add support for new architectural features while keeping support for the older ones. Further, by leveraging the execution thread-group-level (e.g., thread-block-level) programming model with hierarchical memory spaces, the VM 12 exposes the GPU's memory hierarchy, including registers, shared memory, and global memory, that is abstracted away in designs such as Triton [41].

By explicitly exposing this hierarchy, the VM 12 described herein grants programmers fine-grained control over data placement and movement, thereby enabling memory pipelining with computation while avoiding layout conversion shown in FIGS. 3A to 3C. To complement this, the present disclosure provides a data layout system configured to define how the data elements are distributed across a group of execution threads (e.g., thread blocks) for processing. In an embodiment, the data layout system is an algebraic layout system that explicitly defines how elements within a register tensor are distributed among threads in a thread block. For example, this data layout system simplifies the construction, analysis, and interpretation of tensor layouts and enables the reinterpretation of low-precision register tensors as tensors with standard data types, like Step (3) in FIG. 3C.

Furthermore, in an embodiment, the VM 12 provides native support for a wide range of arbitrary low-precision data types, including signed and unsigned integers and floating-point numbers with bit widths from 1 to 8 (e.g., int2 to int8, uint1 to uint8, and float3 to float8), with support for arbitrary exponent and mantissa distributions for floating-point types [19]. These innovations collectively enhance the programmability, efficiency, and flexibility of low-precision kernel development on modern GPUs, setting the VM 12 apart from existing solutions. The VM 12 does not extend Triton because the programming model of Triton inherently abstracts away from tensor layouts, making the system incompatible with the VM 12 and the explicit layout control of the present disclosure. Similarly, Ladder relies on type-level packing, whereas the VM 12 employs tile-level reinterpretation making the two incompatible. In the following description, an example of low-precision matrix multiplication in the VM 12 is provided.

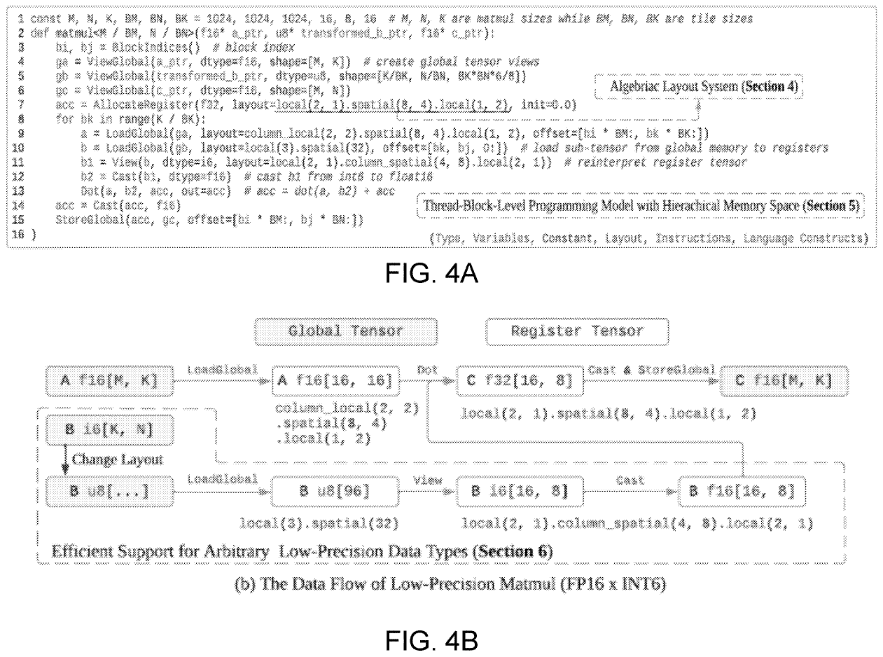

FIGS. 4A-4C shows an example implementation of how to program a low-precision matrix multiplication in the VM 12.

For example, FIGS. 4A to 4C provide a concrete example of using the GPGPU VM 12 (and the program structure Tilus) to implement a low-precision matrix multiplication (matmul) (FP16×INT6). FIG. 4A illustrates the virtual machine program, showcasing key features such as algebraic layout system (Section 4), thread-block-level instructions (Section 5), and efficient low-precision data handling. FIG. 4B illustrates the data flow of the kernel, emphasizing the movement of tensors across the memory hierarchy, and intermediate operations such as tensor reinterpretation and type casting. Similar weight loading flow can be used for arbitrary type widths (Section 6). Finally, FIG. 4C illustrates the register tensor reinterpretation, demonstrating how tensors with compatible bit distributions across threads (e.g., 24 bits per thread) can be seamlessly reinterpreted into different data types and logical layouts.

In an example implementation, the matrix multiplication (matmul) is defined as C_{M,N}=A_{M,K}×B_{K,N}, where A and B have data types float16 (FP16, 16 bits floating number [19]) and int6 (INT6, 6 bit signed integer), respectively.

The kernel performs a matrix multiplication with dimensions M, N, and K, and each thread block is responsible for a BM×BN tile of the C matrix (Line 1). Thus, one needs to launch a grid of (M/BM, N/BN) thread blocks (Line 2). Inside the kernel, first use BlockIndices instruction to get the thread block indices bi and bj (Line 3), and this thread block can be used to compute the C tile with offset (bi*BM, bj*BN). Three tensor views are created in global memory for the inputs and output by specifying the global memory address and the shape of each tensor (Line 4-6). Then, create a f16[16, 8] register tensor with the following layout:
local (2, 1).spatial (8, 4).local(1, 2)

This layout specifies that 32 threads store the 16×8=128 elements in a distributed manner, and each thread stores 4 elements (Line 7). It is a composition of three primitive layouts (Section 4); and it aligns with the layout of the C matrix used by the mma.m16n8k16 tensor core PTX instruction [30]. The reduction loop over k dimension (Line 8-13) repeats loading the tiles of A and B from global memory to register and performing matrix-multiply accumulate (mma). For each iteration, first load a f16[16, 16] tile from global memory to register with a LoadGlobal instruction (Line 9).

The layout of the loaded register tile is specified and used by the tensor core instruction. The offset parameter specifies the position of the loaded tile in the global tensor. The tile loading for tensor B with data type int6 is more complex and will be discussed later in the following description.

In an example implementation, first change the layout of the weight tensor in global memory from i6 [K, N] to u8 [K/BK, N/BN, BK*BN*6/8] to enable efficient loading via the LoadGlobal instruction (i.e., the “Change Layout” step in FIG. 4B). Then, in the kernel, load the transformed tile to a register tensor (Line 10) and reinterpret the loaded tensor to a tensor with another different data type and layout (Line 11). This reinterpretation of the tensor is valid because the tensors before and after interpretation are stored in the same number of threads (32), and each thread holds 24 bits (i.e., 3×u8 or 4×i6), as shown in FIG. 4C. Following this, cast the i6 tensor to f16 tensor (Line 12), which is then fed to the tensor core to compute the matrix-multiply accumulate (Line 13). Finally, cast the accumulation tensor from f32 to f16 and store the result back to global memory (Line 14-15). For simplicity, this program does not use shared memory, omits optimizations such as software pipeline [18], and each k-iteration only perform a single tensor core instruction [29].

The following description provides the three main components of the proposed VM 12 and the corresponding programming structure Tilus. First, an example of data layout system, namely, the algebraic layout formulation is described. The layout system systematically defines how the data elements of a tile are stored in the registers among the threads in a group of execution threads, such as a thread block in this example. Second, the execution thread-group-level programming model with a hierarchical memory space exposed explicitly, is described. In an example, the thread-group-level model is implemented as and hereinafter interchangeably referred to as the thread-block-level model used for GPU programming. Third, the present disclosure provides the native support for arbitrary low-precision data types to meet the increasing need of low-precision computation in deep learning workloads.

### Data Layout System

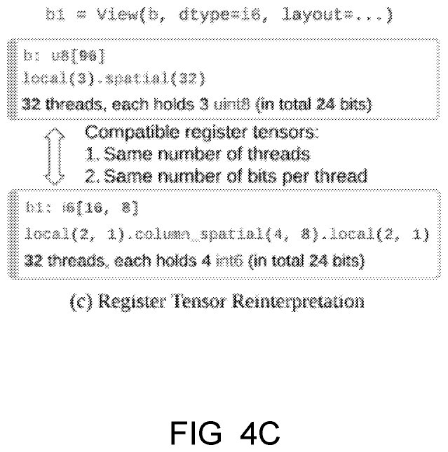

In an embodiment, the VM 12 exposes a hierarchical memory space with global memory, shared memory and registers to the programmers. The system requires a way to model the mapping between the logical index of a tensor element and the location of the corresponding element in memory for all of the three memory scopes. Such a mapping is called the layout of the tensor. FIG. 5 shows an example of the layout used by a tensor core instruction: mma.m16n8k8.f32.f16.f16.f32 D, A, B, C. It performs the following computation D16,8=A_{16,8}B_{8,8}+C_{16,8} where A,B,C,D are tensors stored in thread registers within the same warp (32 threads) in a distributed manner. Since the elements are spread across different threads, this kind of layout is referred to as a distributed layout [41]. Such a layout can be defined as a function f that maps the thread index t and the local index i in this thread to the logical index f(t, i) of the element in the tensor. For example, the layout in FIG. 5 can be represented as:

$$f ( t , i ) = ( t / 4 + i / 2 \times 8 {,}_{t} \% 4 \times 2 + i \% 2 )$$

where 0≤t<31, 0≤i<3, and f(t, i) is the logical index of the element i stored in thread t. Since all threads in a thread block can access the shared memory allocated by the thread block and global memory, this formalization can also be used to describe the layout of shared and global memory by assuming there is only one thread. In other words, define t=0 and let f(0, i) be the logical index of the element at address i of shared or global memory.

As shown in FIG. 5, the operand A with 16×8 elements is distributed across 32 threads with each thread storing 4 elements. The logical index of each element is determined by a layout function given the thread index t and local element index i.

With the formal definition of layout, one can define some parameterized primitive layouts that act as the basic building blocks of the layout algebra. For example, given a tile with shape (n₁,n₂), there are two ways to store it: 1) store all the n₁n₂ elements in a single thread, or 2) distribute all the elements across n₁n₂ threads with each thread holding only a single element.

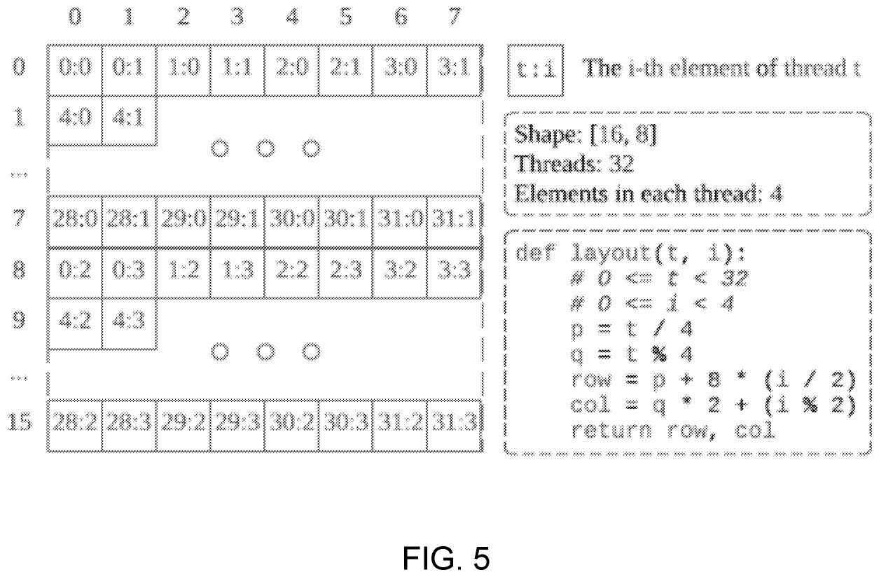

In an example implementation, a first kind of layouts is referred to as “local” layouts and denoted as local(n1, n2). Similarly, a second kind of layouts is referred to as “spatial” layouts and denoted as spatial(n1, n2). The same idea can be extended to tiles with arbitrary number of dimensions. FIG. 6 shows examples of the two primitive layouts. The local (2, 3) layout maps the i-th local element of thread t to logical index (i/3, i % 3) while the spatial (2, 3) layout maps it to (t/3, t % 3). It will be appreciated that the layouts for all common operators in LLMs, such as those used in modern deep learning workloads and GPUs 20, can be constructed with these two primitive layouts.

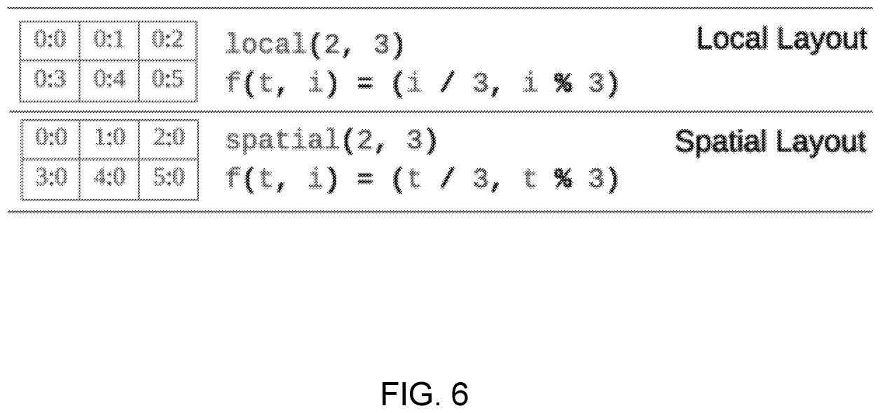

The layout used in modern deep learning workloads and defined in the hardware instruction set usually shows a hierarchical structure. For example, consider the layout c shown in FIG. 7. This layout has shape (4,6) and stores the 24 elements in 6 threads. Each thread holds 4 elements. The 4 elements stored in each thread are denoted as a₀,a₁,a₂,a₃. Comparing the first two rows and the last two rows, it is observed that their structure is similar with only one difference: the last two rows store elements in a₂ and as instead of a₀ and a₁. To model such an invariant sub-structure, the layout c can be viewed as a composition of layout a and b, where each element in layout a represents a tile with layout b. In fact, the layouts a and b can be multiplied to represent the layout c as follows:

$$c ( t , i ) = a ( t / 6 , i / 2 ) ⊙ ( 2 , 6 ) + b ( t \%6 , i \%2 ) ,$$

where 0≤t<6, 0≤i<4, ⊙ is element-wise product, and (2,6) is the shape of the layout c. This layout can be generalized. For example, given two layouts f and g with the same number of dimensions, their composition h=f∘g can be defined as:

$$h ( t , i ) = f ( t / {T}_{g} , i / {N}_{g} ) ⊙ {S}_{g} + g ( t \% {T}_{g} , i \% {N}_{g} ) ,$$

where T_{g}, N_{g}, S_{g} are the number of threads, number of local elements per thread, and the shape of layout g, respectively. One can prove that the composition is associative, that is, for any three layouts f, g, h, the equality f∘(g∘h)=(f∘g)∘h holds. However, the layout composition operation is not commutative, which means that: f∘g≠g∘f. The spatial and local layouts have row-major order for the threads and local elements, respectively. Using the composition, column-major counterparts, column_spatial ( . . . ) and column_local ( . . . ) as illustrated by layout e can be constructed (see FIG. 7).

Coming back to the tensor core instruction layout shown in FIG. 5, one can define it with the composition of parameterized primitive layouts as local(2, 1).spatial(8, 4).local(1, 2).

With layout composition, one can also define its reverse operation. If h=f∘g, define f=h/g as the result of layout h divided by layout g. For example, dividing local(2, 4) by local(1, 2) equals to local(2, 2).

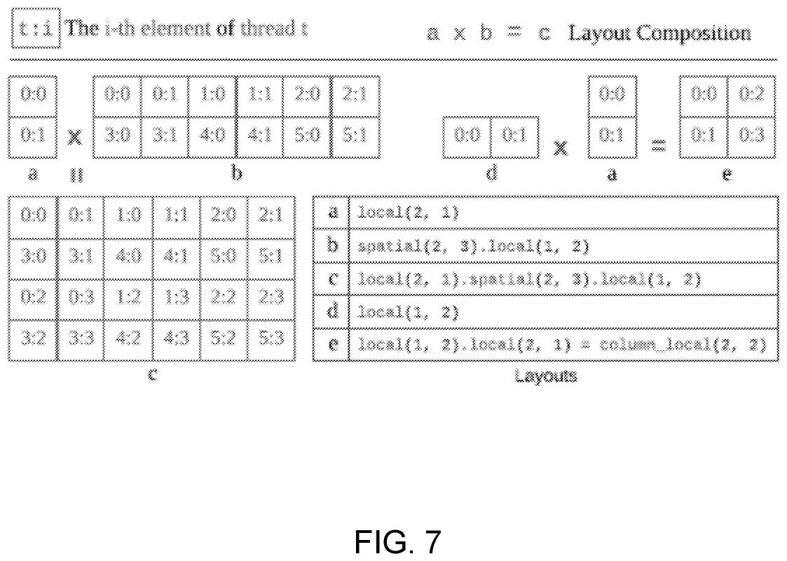

Referring to FIG. 8, an example unified layout representation is illustrated. In an example implementation, the VM 12 uses a unified representation for all layouts of register tensors. This representation gives each layout four attributes: shape, mode_shape, spatial_modes, and local_modes. The shape is a sequence of integers that defines the shape of the register tensor. Each dimension of the register tensor is split into sub-dimensions and concatenate these sub-dimensions to get the mode_shape. Then, spatial_modes and local_modes are used to specify the sub dimensions assigned to spatial threads and to the local storage of each thread. The dimension split-distribute-merge method uniquely defines a register layout.

FIG. 8 shows the example of a layout and how the logical index of a register tensor element are mapped to the pair of thread_index and local_index. There are three steps: 1)split dimensions, 2) distribute sub-dimensions; and 3) merge sub-dimensions. Given the logical index [i, j], first, each index is split into indices of its sub-dimensions (i.e., [i0, i1, i2] for i and [j0, j1, j2] for j) with the unravel operation. After that, the sub-dimension indices are distributed to get the indices for spatial threads (i.e., [i2, j1]) and local storage ([i0, j0, i1, j2]). Finally, the multi-dimensional indices for threads and local storage are converted into linear index to get the thread index and local index. The ravel and unravel functions are used to convert between multi-dimensional index in a grid with given shape and its row-major linear index. For example, unravel (i, [4,2,8])=[i/16, i/8% 2, i % 8], and ravel ([i2, j1], [8, 4])=i2*4+j1.

The layouts represented in this form are closed under the composite layout, which means that the product result of two layouts in this form can also be represented in this form.

Modern GPU programming models, such as PTX [30] and CUDA [29] define the instructions (or operations) executed by a thread (i.e., at thread level), thereby specifying the kernel's behavior. This programming model is known as Single-Instruction-Multiple-Thread (SIMT) paradigm [1]. In an embodiment, to simplify the programming behavior of the computational processing unit (e.g., GPU), the present disclosure provides a thread-group-level (e.g., a thread-block-level) programming model, defining operations at the granularity of groups of execution threads (e.g., thread block) rather than individual threads. Additionally, building on the data layout system (e.g., the algebraic layout system) described above, the present disclosure further provides explicitly exposing the hierarchical memory space, for example, in the modern GPUs, enabling fine-grained memory control while reducing programming complexity. This programming model is referred to as Single-Instruction-Multiple-Block (SIMB).

In an example implementation, the VM 12 supports three types of variables. Scalar variables represent the most basic type of data, and store individual values such as integers (e.g., int32) or floating-point numbers (e.g., float16). Pointer variables, on the other hand, store memory addresses instead of direct data values. Each pointer is associated with a specific data type, indicating the type of data the pointer references.

Tensor variables represent multidimensional data structures or arrays, with types that specify their shape, element type, memory scope, and layout. Tensors can be stored across different memory scopes, such as global memory, shared memory, or registers, enabling representation and computation of high-dimensional data. The tensor layout determines how the high dimensional tensor elements are mapped to the linear memory space. All these variables in the virtual machine 12 operate at the thread-block-level, meaning that all threads in the thread-block collaboratively allocate and maintain their state.

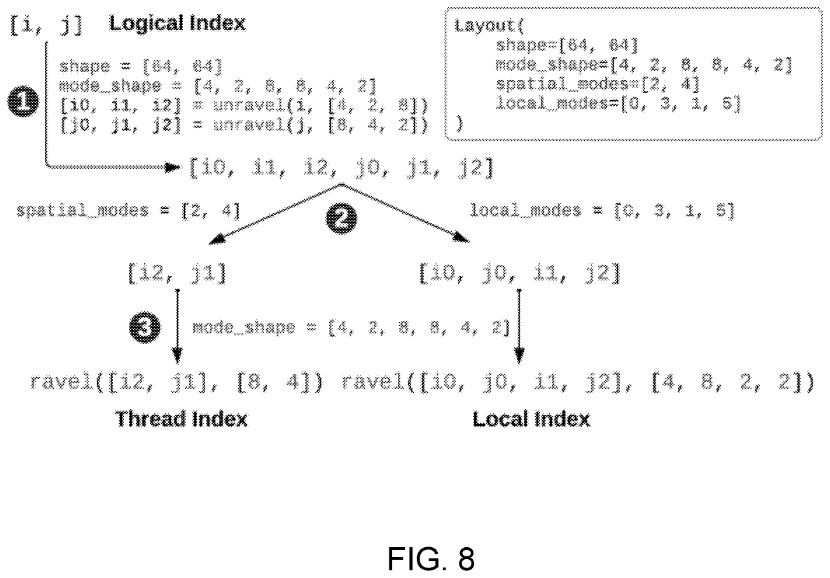

FIG. 9 shows an example of the VM program structure of Tilus. For example, the program structure contains parameters and a body. The body is a list of control-flow statements or block level instructions. The majority of functionality, such as tensor allocation and computation, is provided by the instructions.

In an example implementation, each program is defined with a program name, grid shape, a list of parameters, and the program body. The grid shape includes a list of expressions enclosed in < . . . >; and each expression can be either a positive integer, or an integer expression of the program parameters. In this case, the grid shape is determined by the program launching arguments. Only scalar variables or pointer variables are allowed to be program parameters in this illustration. The program body includes a sequence of statements, including if-else statement, range-based for-loop, and while loops.

Unlike other low-level virtual machine [30] or instruction set architectures (ISA) [31], the following does not abstract these control-flow statements into jump instructions since the VM 12 proposed herein is aimed to be able to be programmed by human; and control-flow statements are more natural and easier to understand and program. Besides these control flow statements, individual instructions can also be a statement, and most functionality provided by the virtual machine 12 have been defined as instructions in the thread-block-level instruction set.

In an embodiment, the instruction set in the VM 12 is configured to abstract the operations from thread level to thread-block level. Each instruction defines an operation for the whole thread block, instead of a single thread. The variables that are manipulated by the instructions are also managed by the whole thread block instead of a single thread.

Table 1, shown below, illustrates an example of a thread-block-level instruction set in the virtual machine. Each instruction defines an operation applied to the entire thread block. The instruction parameters enclosed in [ . . . ] are optional. Instructions that return a new register tensor also have a corresponding in-place version that writes the result to an existing register tensor using the out parameter instead of creating a new tensor.

TABLE 1
Thread-Block-Level Instruction Set in VM 12

| Category | Instruction | Semantics |
|---|---|---|
| Indexing | indices [symbol] BlockIndices( ) | Get the indices of the current thread block in the grid. |
| Tensor | global_tensor [symbol] | Allocate a tensor in global memory with the given data |
| Creation | AllocateGlobal(dtype, shape, [layout]) | type, shape, and optional layout. |
| | shared_tensor [symbol] | Allocate a tensor in shared memory with the given data |
| | AllocateShared(dtype, shape, [layout]) | type, shape, and optional layout. |
| | register_tensor [symbol] | Allocate a tensor in registers with the given data type, |
| | AllocateRegister(dtype, shape, [layout]) | shape, optional layout and unit value. |
| | glo [symbol] al_tensor [symbol] | Create a tensor view in global memory gives the pointer, |
| | View [symbol] (ptr, [dtype], shape, [layout]) | data type, shape, and layout. |
| Tensor | register_tensor [symbol] | Load a tensor from global memory to register, |
| Transferring | LoadGlobal(global_tensor, layout, offset) | given the layout and offset. |
| | register_tensor [symbol] | Load a tensor from shared memory to register, |
| | LoadShared(shared_tensor, layout, offset) | given the layout and offset. |
| | StoreGlobal(register_tensor, | Store a register tensor in the global tensor at the given offset. |
| | global_tensor, offset) | |
| | StoreShared(register_tensor, | Store a register tensor in the shared tensor at the given offset. |
| | global_tensor, offset) | |
| | CopyAsync(shared_tensor, global_tensor) | Issue an asynchronous copy task from global tensor in shared tensor. |
| | CopyAsync [symbol] Group( ), | Commit CopyAsync instructions as a group, or wait until there are |
| | CopyAsync [symbol] Group(n) | only [symbol] ongoing groups. |
| Register | [symbol] ( [symbol] , [symbol] , [symbol] , Div, [symbol] )(a, b); [symbol] Neg( [symbol] ) | Arithmetic operations. |
| Tensor | [symbol] Cast( [symbol] , dtype) | Cast a register tensor from one data type to another without |
| Computation | | changing the layout. |
| | [symbol] ( [symbol] , [dtype], [layout]) | Reinterpret a register tensor with another data type and layout |
| | | at no cost. |
| | [symbol] Dot(a, b, c) | Compute the dot product: d [symbol] dot(a, b) + c. |
| Control | Synchronize( ), Exit( ) | Synchronize or exit the thread block execution. |
| Debug | Print(tensor) | Print a tensor to standard output. |

[symbol]

indicates data missing or illegible when filed

Table 1 shows a list of the instructions in the instruction set, with the signature of each instruction and a brief description about what the instruction does. These instructions allocate tensors with specific data types, shapes and layouts in specific memory spaces (e.g., global memory, shared memory, registers); transfer tensors from one memory space to another; and perform computations or transformations of register tensors. The execution model of modern processors (e.g., GPU) allows different warps to execute different instructions at the same time. Similarly, the execution of instructions in the virtual machine exhibits this behavior: certain subsequent instructions may begin execution before the current instruction completes, resulting in multiple block-level instructions being in flight simultaneously. Generally, this behavior does not pose significant issues. However, one exception arises when a thread block accesses the same region of shared or global memory space with two instructions, and the subsequent instruction depends on the completion of the previous one. In such cases, a Synchronize instruction is inserted to ensure that all preceding instructions are completed before executing subsequent ones.

Modern processors use bytes (e.g., 8 bits each) as the smallest processing unit. Thus, all standard data types in modern programming languages have 8 or a multiple of 8 number of bits. However, due to the large computation and memory requirement by LLMs, low-precision data types with fewer than 8 bits are playing more and more important role to reduce computation and memory consumption. The following describes how the VM 12 supports the low-precision data types with bit widths from 1 to 8, efficiently.

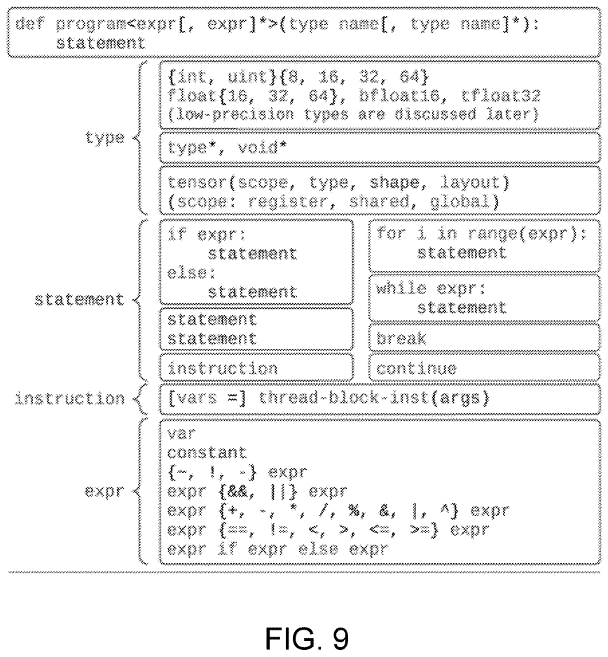

There are three categories of numerical data types: signed integer, unsigned integers and floating numbers that are widely used in deep learning and this discussion focuses on the low-precision correspondents of these data types. Unsigned integer data type with n bits represents integer values from 0 to 2ⁿ−1 (inclusive). Signed integer data type with n bits takes one bit as the sign bit and the remaining bits as magnitude bits and represents integers from −2ⁿ−1 to 2ⁿ⁻¹−1. The floating numbers are more complex, whose bits are partitioned into three parts: sign bit, exponent bits and mantissa bits, with encoding:

$$Value = {( - 1 )}^{S} \cdot ( 1 + Mantissa ) \cdot {2}^{Exponent - Bias}$$

where S and Exponent are the raw values of the sign bit and exponent bits, Mantissa represents the fractional part encoded by the mantissa bits, and Bias=2^{e-1}−1 is the exponent bias for e-bit exponents. FIG. 10 illustrates 5-bit variants for these data types, with the bit partition and representable set. It illustrates low-precision data types: int5, uint5, and float5_e2m2. The e2m2 in float5_e2m2 denotes that it has 2 bits for exponent and 2 bits for mantissa. Only the nonnegative numbers for data type float5_e2m2 are shown.

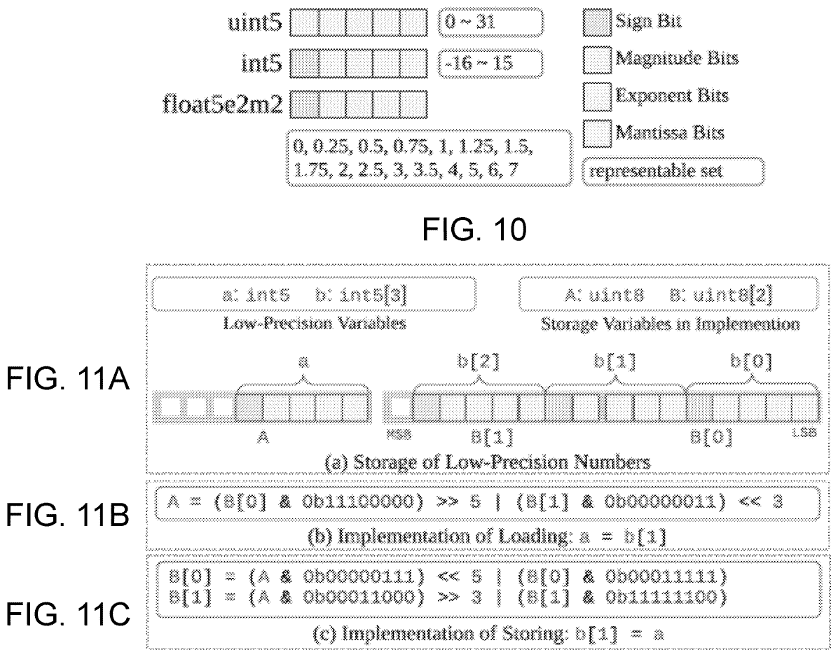

Since modern processors, including CPUs and GPUs 20 use bytes with 8 bits as the minimal unit of memory loading/storing and computation, one may store the low-precision data with fewer than 8 bits in uint8 (one byte) in a compact manner, as shown in FIGS. 11A to 11C. FIG. 11 shows a compact storage and accessing of low-precision data type, in which the low-precision numbers are stored in a compact manner. FIG. 11A shows use of the uint8 data type as the storage of low-precision data. Some low-precision numbers might be stored in two consecutive bytes. FIGS. 11B and 11C show implementation of the low-precision element loading and storing by converting the accessing into bit-wise operations.

The compact storing means that one does not need to leave any bit gap between two consecutive low-precision values, and this might cause one low precision value storing in two uint8 (e.g., the b[1] in the FIGS. 11A-11C). Use the bitwise operations to extract, manipulate and store the low-precision values within packed byte arrays. To load a low-precision value, relevant bits are extracted using bitwise AND their position is adjusted using bitwise SHIFT, and finally use bitwise OR to combine separate parts together if the low-precision value spans multiple bytes. Similarly, to store a low precision value, clear the target bit positions using bitwise mask, then insert the new value using bitwise OR while preserving the other bits. Low-precision data is cast to standard data types before arithmetic computations and is cast back afterward. While these methods enable support for arbitrary bit-width data types, they can be inefficient. They serve only as a fall back mechanism. Thus, more efficient handling of low-precision data is necessary for LLM serving.

An efficient low-precision support for LLMs is provided in the present disclosure. The low-precision kernels in an LLM 14 usually take two steps to handle the low-precision weights and computations: 1) load the weight into on-chip memory (register or shared memory) from global memory, and 2) cast the low-precision weights into high-precision weights (e.g., float16) and perform de-quantization. Thus, efficient memory loading and casting of arbitrary low-precision data get important.

Efficient Low-Precision Weight Loading: With the low-precision support presented in the description above, the VM 12 is able to directly use LoadGlobal instruction to load tensors with low-precision data type. However, it may not be efficient to directly load in this way, because it can generate multiple bitwise instructions and the memory access pattern is not hardware-friendly (e.g., the global memory access is not coalesced [29]). To address this issue, the layout of the weight tensor in global memory is transformed to make the memory loading more efficient. Taking the example in FIG. 4, when there is not weight layout transformation, a register tensor may be loaded with dtype i6 and layout local(2, 1).column_spatial(4, 8).local(2, 1) results in non-contiguous memory access, causing multiple memory access transactions. The low-precision data type can make things worse since one would need to use multiple bitwise operations to extract the desired bits. By examining the data type and layout of the register tensor, one can find a compatible tensor type with dtype uint8 and layout local(3).spatial(32) that has the same number of threads and number of local elements per thread, while enabling efficient memory loading.

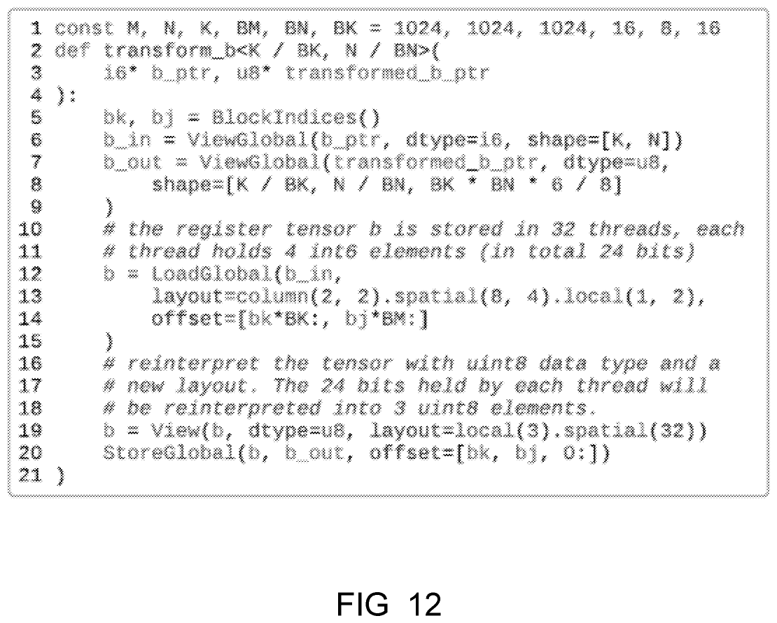

Thus, as shown in FIG. 12, the weight tensor with shape [K, N] is partitioned into [K/BK, N/BN] tiles and each tile has shape [BK, BN]. In an example implementation, each tile is reinterpreted from i6[BK, BN] to tile u8[BK*BN*6/8](Line 19) and stored in contiguous memory (Line 20). After such transformation, when one wants to load a tile, use instructions in FIG. 4A (Line 10, 11) to load the tile in a hardware-friendly way. More importantly, the transformation allows the VM 12 to use pipelined asynchronous memory transfers from global memory to shared memory like standard data types and avoid any layout conversion that relies on shared memory. A similar method could be applied to load a register tensor with arbitrary low-precision data type and layout from global memory.

For example, if there are n bytes in each thread and T threads, the register tensor is reinterpreted as a tensor with data type uint8 and local(n2).spatial(T).local(n1) layout for vectorization, where n₁=gcd(n,16) and n2=n/gcd(n₁,16). Here, gcd(a, b) denotes the greatest common divisor of a and b.

Efficient Casting: In an embodiment, after weights loading, the VM 12 casts the low precision weights stored in each thread from low-precision data type into a high-precision data type (e.g., float16) so that they can participate in the subsequent computation if the hardware does not have native support for the corresponding low-precision data type. For example, the target-specific instructions are used to perform the casting efficiently in a vectorized manner. For example, on CUDA platform, the PRMT (permute bytes in a 32-bit register), LOP3 (arbitrary logical operation on 3 inputs), and bitwise instructions can be used to perform the casting with vectorization and with minimal overhead, as all the operations are performed within registers and do not require any communication between threads.

In an example implementation, the VM 12 and the corresponding programming structure provides five main components: a domain specific language (DSL) in Python, an intermediate representation (IR), optimization passes, a code generator, and a runtime system. The DSL enables developers to write programs in Python, which are then translated into the VM's IR for further processing. Optimization passes refine the IR by eliminating redundancies and simplifying arithmetic expressions. The code generator is configured to translate the optimized IR into Hidet IR, a CUDA C-like intermediate representation. Subsequently, the transformations are applied to implement low-precision operations using standard precision types while preserving original semantics. The final CUDA C code is generated from the Hidet IR and compiled into a hardware binary using the nvcc compiler. The runtime system manages dynamically loaded binaries and provides the execution environment. The entire system includes approximately 35k lines of Python and C++ code.

The domain-specific language (DSL) for the VM 12 in Python provides a user friendly interface that allows programmers to directly write the VM programs in Python, making it easy to integrate the produced kernels with the rich deep learning ecosystem. Given a program in the proposed VM 12, several steps may be taken to compile it to GPU executable code.
Step 1: Global and Shared Memory Planning. Each GPU kernel could use some launch-time known size of shared memory space. To simplify GPU programming, allow the users to allocate shared memory multiple times in the program on demand. Thus, this may require a shared memory planner to calculate the size of shared memory the virtual machine and/or the program structure needs and map the shared tensor to one region of the kernel's shared memory space. One can reuse the shared memory space when two shared tensors do not live at the same time.

Similar to shared memory planning, the system may use a global memory planner to manage the allocation of global memory shared by all thread blocks. Request a runtime system of the VM 12 to allocate a workspace in global memory, enabling the kernel to use this workspace via AllocateGlobal instructions during its execution in addition to the input and output tensors.
Step 2: Code Emitting for Each Instruction: In an example implementation, low-level GPU code is emitted for each VM instruction one by one or sequentially. In the proposed implementation, one can use the Hidet IR [10] to represent the low-level GPU code. During this process, instruction selection is performed to choose the most efficient low-level instructions, where feasible. For the same VM instruction, one may have multiple low-level GPU code to fulfill its functionality. For example, one can use Ids PTX instruction [30] to load the data from shared memory to register. However, a more efficient PTX instruction Idmatrix could also be used if the layout of the loaded register tensor is compatible with the layout spatial(8, 4).repeat(1, 4), which means it can be divided properly by the latter. The compiler being used can try to select the most efficient instructions. Besides, one may also perform automatic vectorization for memory loading and storing instructions. For example, the vectorized instructions such as cp.async.v4, Ids128 and Idg128 are used to maximize the memory accessing efficiency.
Step 3: Lowering Low-Precision Data Types: After emitting thread-block-level instructions to the low-level IR, apply the passes that implement the rules described above to transform all low-precision operations in the low-level IR to corresponding operations on hardware-friendly types. In most cases, only the vectorized type casting from low-precision type to standard type (e.g., float16) is applied since the memory loading of low-precision data will be replaced by standard types due to the layout formalization and register tensor reinterpretation. Subsequently, CUDA code (for example, for NVIDIA GPUs) from the low level IR (e.g., the Hidet IR) and then use the nvcc compiler to produce the hardware binary that can be dynamically loaded.
Step 4: Loading by Runtime System: The compiled binary is dynamically loaded by the virtual machine runtime system. The runtime also maintains internal states to serve the kernel execution: 1) an on-demand allocated workspace memory that can be requested by the compiled kernels via AllocateGlobal instruction; 2) an execution context that stores the CUDA stream that the kernel is launched on; 3) the kernel cached in memory to avoid unnecessary recompilation.

### Evaluation of the VM and the Programming Structure, ‘Tilus’

### Experimental Setup

Workloads. Benchmark three representative LLMs 14 with varying model sizes: Gemma-2-9B [39], QWen2.5-32B [52], and Llama-3-70B-Instruct [43]. Both the prefill and decode stages are evaluated. For operator-level analysis, we focus on matrix multiplication kernels extracted from these models. The described system, VM 12 and the corresponding programming structure supports all kernels supported by the conventional systems, such as Triton. However, quantized matmul is focused on in the experiments described in the present disclosure.

Baselines. Compare the approach, VM 12 and the corresponding programming structure, Tilus, against the vendor library cuBLAS [28], state-of-the-art deep learning compilers Triton [41] and Ladder [47], and hand-crafted kernels QuantLLM [50] and Marlin. Auto-tuning for Triton [41] and Ladder [47] was enabled, while QuantLLM [50] used its heuristic policy to choose kernel hyperparameters. For end-to-end evaluations, integrate the quantized kernels into the state-of-the-art LLM serving framework vLLM [21] and compare against vLLM [21] and Ladder [47] in end-to-end execution. The specific versions of the tools used are as follows: vLLM v0.5.3, Triton v3.1.0, bitblas v0.0.1.dev15 (Ladder [47]), QuantLLM with commit 9802c5a, and Marlin v0.1.1.

Hardware Configuration. Experiments were mainly conducted on a server equipped with an NVIDIA L40S GPU (48 GiB), with GPU driver 565.57.01 and CUDA Toolkit 12.6.3. Benchmarks were also conducted on NVIDIA A100 and H100 GPUs to demonstrate the general applicability of the described approach of the present disclosure across different hardware platforms.

Experimental Protocol. For operator experiments, each kernel was executed 50 times, while for model experiments, each model was executed 10 times. In both cases, latency was measured using CUDA Events [29], and the median latency was reported. To eliminate artifacts from consecutive runs, the L2 cache was cleared before each execution.

### Performance of Low-Precision Kernels

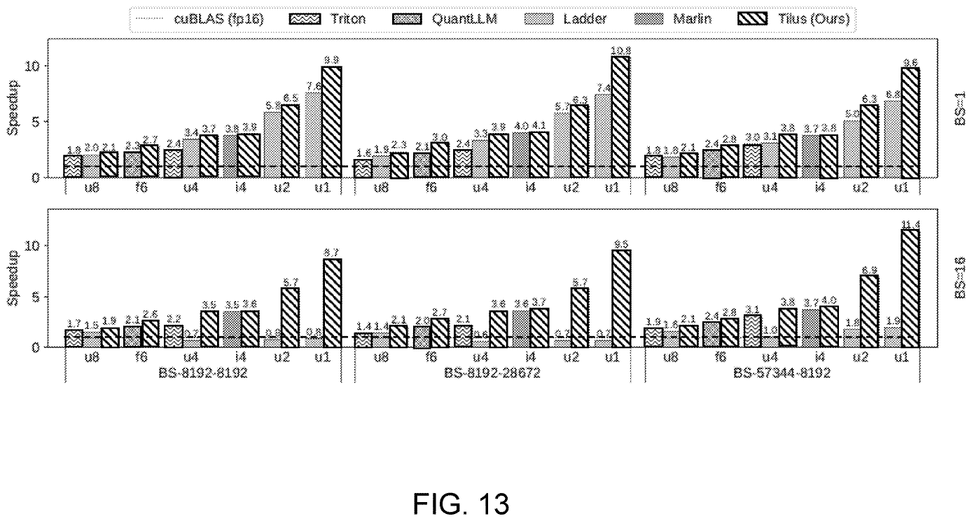

FIG. 13 compares the speedup of low-precision kernels in Triton [41], QuantLLM, Ladder, and Tilus (i.e. the VM 12) against the standard half-precision kernel from cuBLAS. Benchmarked data types include uint8 (u8), f6e3m2 (f6), int4 (i4), uint4 (u4), uint2 (u2), and uint1 (u1). Each workload (BS-N-K) corresponds to a matrix multiplication in Llama-3.3-70B, with batch sizes 1 and 16.

A single virtual machine program template is implemented to support matrix multiplication with all quantized types, taking tile sizes as tunable hyperparameters. The performance of this auto-tunes program is denoted as Tilus (the programming structure based on the VM 12) in the evaluation. While each baseline supports a limited set of quantized data types, Tilus achieves consistent speedups across all benchmarked matrix multiplications. When batch size is small, the bottleneck for low-precision kernels becomes loading weights from global memory to registers for computation on either SIMT cores or Tensor Cores. Triton struggles with this scenario. Triton may incur significant overhead due to expensive layout conversions performed after weights are already loaded into registers. While this conversion could be avoided by reformatting the data in global memory beforehand, Triton's programming model is found to not allow users to specify data layouts at the thread level, making preemptive conversion not possible. Ladder addresses this by altering the data layout in global memory, avoiding redundant conversion issue. However, Ladder's primitives are found to lack critical optimizations, such as software pipelining [18, 27] and its type-level packing limits efficient support for arbitrary bit widths, leading to underutilized memory bandwidth. Expert-crafted kernels from QuantLLM and Marlin are optimized for specific quantization schemes but lack flexibility and maintainability.

In contrast, VM 12 or Tilus consistently outperforms all baselines using a single parametrized Tilus program template, which efficiently supports a full range of quantization types through a well-abstracted programming model.

The proposed VM 12 supports low-precision matrix multiplications of the form matmul (A, B), where operand A can have data types with 32, 16, or 8 bits, and weight B supports a wide range of bit widths, from 32 bits down to 1 bit. Standard data types such as float32, float16, and int8 are supported, along with customized low-precision types with fewer than 8 bits, which include signed integers, unsigned integers, and floating-point formats with arbitrary exponent and mantissa distributions. Leveraging the algebraic layout system, the VM 12 enables efficient memory access for low-precision data. It eliminates overhead by transforming layouts to load data directly from global memory into on-chip storage (shared memory and registers) as efficiently as standard types. Casting from low-precision to higher-precision types is performed in registers through thread-level vectorized operations, ensuring that casting overhead is negligible and does not bottleneck performance.

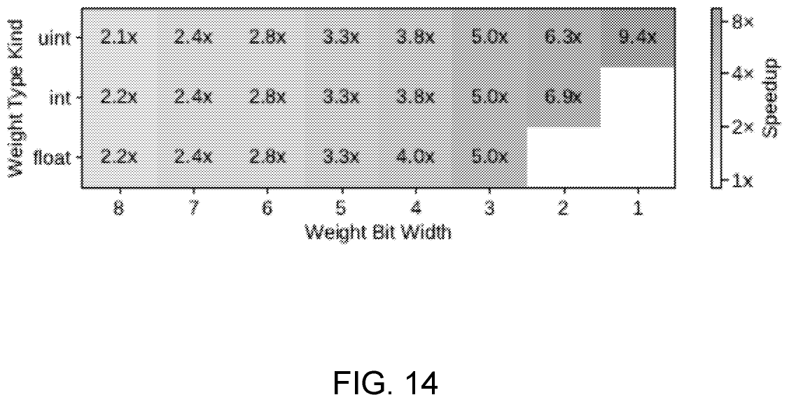

FIG. 14 illustrates the speedup achieved for the full-spectrum of quantized weight data types: uint1 to uint8, int2 to int8, and float3 to float 8. Representative exponent-mantissa distribution of floating point data types such as e4m3, e3m3, e3m2, e2m2, e2m1, and e1m1 are chosen.

Each row represents type kind (e.g., unsigned integer, signed integer or floating data type), while columns show the bit width. Using matrix multiplication dimensions of BS=16, K=8192, and N=57344, the results demonstrate substantial speedups. These findings validate that our VM can effectively represent and execute arbitrary low-precision kernels with high efficiency, making it a robust solution for low-precision computations in modern workloads. Notably, all kernels are generated from the same program template by parametrizing tile sizes, which limits the required programming effort. There are around 200 configurations per operator, and it takes around one minute to compile. For this experiment, float16 is used as the activation data type and bfloat16 and int8 data types are also supported.

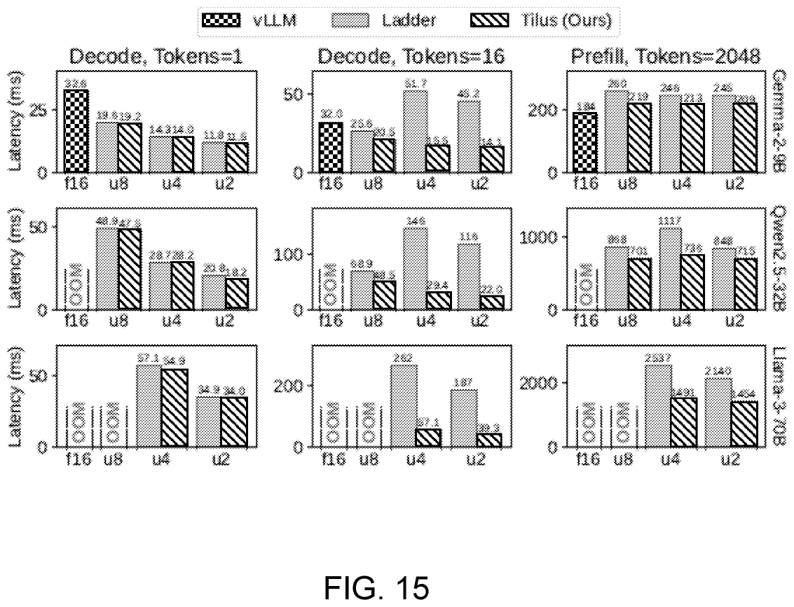

The end-to-end performance of representative LLMs was evaluated: Gemma-2-9B [39], QWen-2.5-32B [52], and Llama-3.3-70B [43], across both prefill and decode stages. The prefill stage processes all prompt tokens at once, generating the kv-cache for subsequent token generation during the decode stage, which iteratively generates one token at a time. Prefill latency determines the time-to-first-token (TTFT), while decode latency impacts the speed of subsequent token generation. Both stages are found to be important for optimizing user experience and system utilization. Contiguous batching [21, 53] was used to batch multiple decode requests efficiently. FIG. 15 shows end-to-end performance across representative LLMs. In particular, FIG. 15 shows the latency of both stages across these models. The first two columns correspond to the decode stage with 1 and 16 tokens, respectively, while the third column shows latency for the prefill stage with 2048 prompt tokens.

The methods described herein can consistently outperform Ladder [47], particularly in the decode stage for batch sizes greater than one (middle column of FIG. 15). Analysis of Ladder's generated kernels revealed suboptimal use of CUDA Cores for 1-15 tokens and Tensor Cores for 16 or more tokens, as key optimizations like software pipelining [18] and k-dimension parallelization [33] were not implemented, leading to poor performance. For the prefill stage, quantized weights are decoded to float16 and computations are performed using standard f16×f16 matrix multiplication kernels, as computation becomes the bottleneck at this stage. The proposed efficient handling of quantized weight layouts can ensure minimal overhead for decoding, contributing to the improved computational performance observed.

### Case Studies

Speedup over Different Hardware

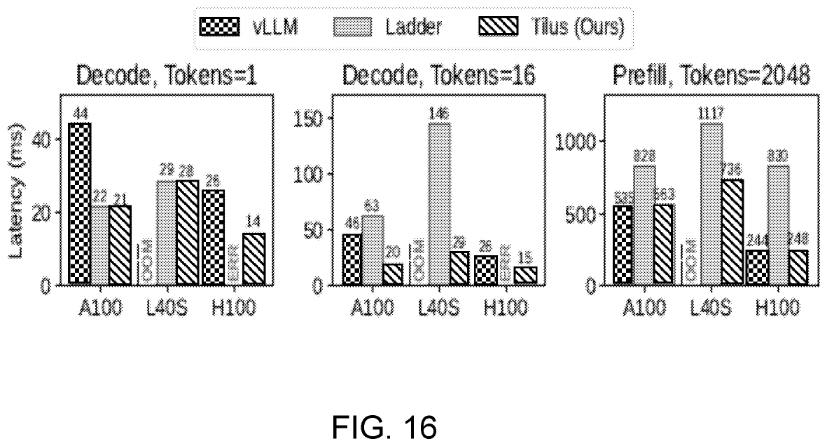

The end-to-end performance of the QWen2.5-30B model on NVIDIA A100, L40S, and H100 GPUs, representing Ampere, Ada Lovelace, and Hopper architectures, respectively. FIG. 16 compares the performance of vLLM [21](float16), Ladder [47](uint4), and Tilus (uint4) during the decode and prefill stages. Specifically, FIG. 16 shows the end-to-end performance of the QWen2.5-30B model across NVIDIA A100, L40S, and H100 GPUs. The weight data types for vLLM, Ladder, and Tilus are float16, uint4, and uint4, respectively. OOM indicates out-of-memory error, and ERR indicates a runtime error.

On the Hopper architecture (H100), Ladder [47] encounters kernel generation issues, resulting in a CUDA error (“an illegal instruction was encountered”), marked as ERR. Additionally, the float16 weights in vLLM [21] exceed the 48 GiB memory capacity of the L40S GPU, causing out-of-memory errors (OOM). For all other scenarios, VM 12 or Tilus was found to consistently outperform Ladder across all GPUs 20 and stages, demonstrating robust cross-architecture generalizability. These results underscore the adaptability and efficiency of the proposed approach, particularly in overcoming the challenges of diverse GPU architectures and resource constraints.

Speedup over Different Batch Sizes

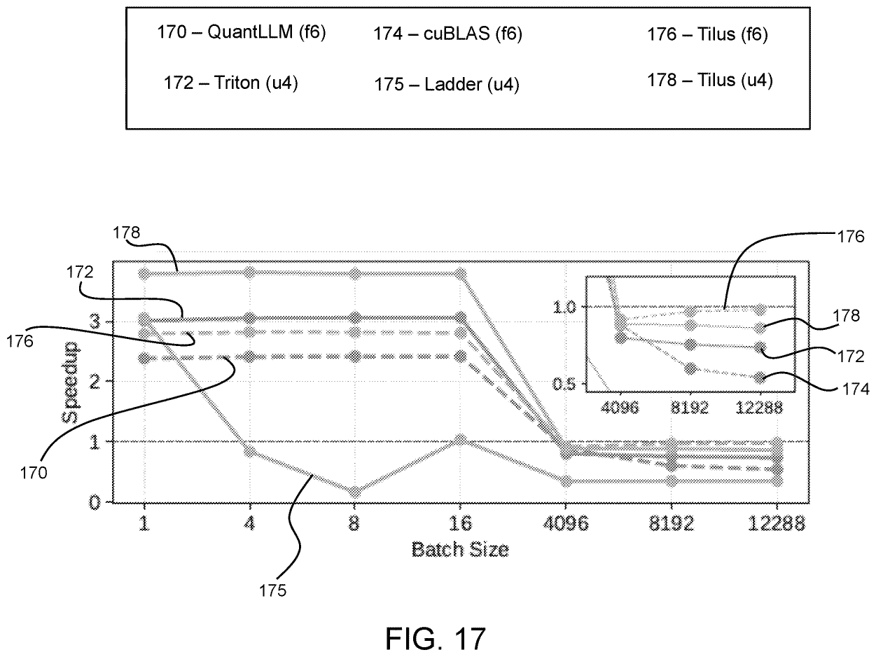

The relationship between the speedup and batch sizes was also studied by benchmarking marking matrix multiplication performance under different batch sizes. Choose batch size 1, 4, 8, 16 for decode stage and batch size 4096, 8192, 12288 for the prefill stage. The batch size corresponds to the number of tokens processed in one step. In the prefill stage, it equals the sum of sequence length of all requests since each request only generates one token each time. Experiments are conducted on Llama-3.3-70B instruct with quantized data types float6_e3m2 (f6) and uint4 (u4), using k=8192 and n=57344. As shown in FIG. 17, Tilus was found to outperform the baseline approaches across all batch sizes that are used in both decode and prefill stages in LLM serving.

### Profiling of Quantized Kernels

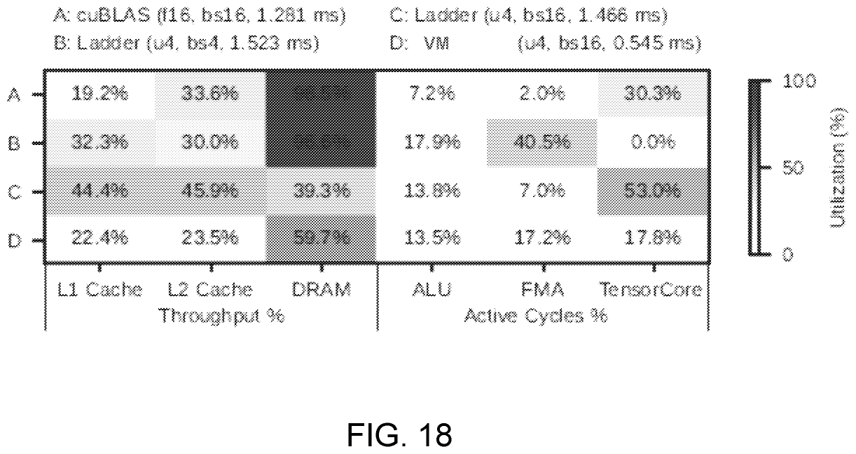

In one example, Nsight Compute is used to profile the kernels of cuBLAS, Ladder, and VM 12, with results shown in FIG. 18. Here, GPU utilization for cuBLAS, Ladder, and VM 12 kernels is shown. The figure details the throughput utilization of memory units and pipeline utilization of computation units. The figure details GPU hardware utilization, dividing it into throughput utilization for L1 Cache, L2 Cache, and DRAM (first three columns) and computation unit utilization for ALU, FMA, and Tensor Core (last three columns). Specifically, ALU handles bit manipulation and logical instructions, FMA performs fused multiply-add operations for integers and floating-point numbers, and Tensor Core represents the utilization of NVIDIA's specialized Tensor Core pipeline [29]. From row B of FIG. 18, Ladder kernels primarily rely on CUDA Cores, with 40.5% FMA utilization and no Tensor Core usage. However, the kernel suffers from significant DRAM bandwidth limitations (96.6% utilization), as each thread independently loads operand A from global memory without exploiting shared memory for data reuse. This inefficiency worsens with larger batch sizes, as seen in FIG. 16, where performance degrades for batch sizes of 1, 4, and 8 [47]. For batch sizes of 16 or more, Ladder transitions to Tensor Core usage (row C, FIG. 18). Despite this transition, Ladder does not utilize cp.async for asynchronous memory transfers or software pipelining to overlap computation and memory operations.

These limitations can hinder efficient resource utilization. Additionally, Ladder's Tensor Core execution strategy is considered to be flawed; padding in the batch size dimension results in tensor core instructions up to eight times more than necessary. In contrast, VM 12 overcomes these inefficiencies using an algebraic layout system. It can interpret quantized weights with standard data types and employ cp.async to optimize memory access patterns. Moreover, VM 12 integrates software pipelining to overlap memory transfers and computation, leading to superior performance, as evident in row D of FIG. 18.

Many deep learning compilers adopt loop-oriented scheduling [7,34] and establish auto-tuning frameworks on top of it [2, 14, 36, 44, 46-48, 51, 55-58]. In contrast, VM 12 or Tilus leverages a procedure oriented approach to model GPU hardware, significantly enhancing GPU programmability and flexibility. Beyond loop-oriented scheduling, tensor programs are often optimized using vendor-provided kernel libraries (e.g., cuBLAS [28]), predefined templates for efficient matrix multiplication [27], hardware-aware tiling strategies [60], and domain specific compilers for linear algebra [35]. These methods focus on performance but lack extensibility for arbitrary low-precision data types. Several works address optimizations for irregular or ragged tensor programs [13, 38], operator fusion [54, 59], dynamic shape support [12, 37, 55, 61], and scheduling of independent operators [11, 20, 25]. Prior works endeavor to support quantization with arbitrary bit-width by independently processing different bits. However, these methods are primarily limited to integer quantization and often exhibit suboptimal performance. PartIR also introduces a layout system for tiles but its abstraction level is higher than that of the proposed VM 12 and Tilus's, described in the present disclosure, and it does not detail the assignment of tile elements to threads. Further, ExTensor and FuseMax leverage einsum to define computations, implicitly determining memory access patterns. Nevertheless, they do not specify how tile elements are distributed among GPU threads. Tilus, as described herein, can accommodate codebook quantization, such as LCQ to facilitate low-precision computation through the addition of a new lookup instruction. Microscaling data types can be considered as a more fine-grained quantization and thus, the VM 12 and Tilus described herein, can also support the same. These techniques are complementary to the focus of the present disclosure, i.e., on efficient low-precision computation. Triton [41] introduces a tile-based programming model with thread blocks as the main programmable unit. However, it has been found to lack support for low-precision data types and does not expose the GPU memory hierarchy or register-level tile placement, limiting its optimization potential. Similarly, Hidet [10], which can be used as the backend in the present system, does not support low-precision data types. Graphene [16]proposes an intermediate representation (IR) with a layout representation system for GPU optimization. Unlike Graphene's focus on strides and computation, the algebraic layout system described herein emphasizes hierarchical organization. In fact, one can also abstract the layouts in Graphene [16] as a primitive layout in the layout system.

The present disclosure provides a novel GPGPU VM 12 and the corresponding programming structure Tilus, tailored to expose shared memory and registers to developers, which enables creation of efficient low-precision kernels for LLM serving. The system includes a data layout system (e.g., the algebraic layout system) for tensor distribution in thread block registers, a thread-block-level programming model with fine-grained memory management, and comprehensive support for sub-byte data types, enabling arbitrary precision from 1 to 8 bits. Experiments demonstrate significant performance gains over state-of-the-art frameworks, such as Triton and Ladder, highlighting the flexibility and scalability of this approach. This can provide a foundation for efficient, extensible LLM inference and can be used for further optimization across emerging hardware, advanced quantization techniques, and diverse low-precision formats.

### Layout Formalization

This following section provides example formalization of the concept of layout, define primitive layouts, composition, division operators, and layout broadcast. Furthermore, the following is used to prove that the set of layouts with the composition operator forms a monoid.
Definition 1 (Layout). A layout f is a function that maps a pair of thread index t and local element index i to the logical index I of the element in the tensor:

$$I = f ( t , i ) , 0 \leq t < T , 0 \leq i < m , I ∈ {N}_{n 1} \times {N}_{n 2} … {N}_{n r} ,$$

where T is the number of threads, m is the number of elements each thread holds, r is the rank of the tensor, Nₒ={0, 1, . . . , n−1} and S=(n₁, n₂, . . . , nᵣ) is the shape of the tensor.
Definition 2 (Local Layout). Given an r-rank tensor with shape (n₁, n₂, . . . , nᵣ), define the local layout local(n₁, n₂, . . . , nᵣ) as a layout with a single thread (T=1), where all elements of the tensor are stored in row-major order:

$$f ( t , i ) = ( i / ( {n}_{2} {n}_{3} … {n}_{r} ) , i / ( {n}_{3} {n}_{4} … {n}_{r} ) \% {n}_{2} , … , i \% {n}_{r} ) .$$

Here, 0≤t<1=T and 0≤i<n₁n₂ . . . nᵣ=m. In code, represent such a layout as local(n1, n2, . . . , nr).
Definition 3 (Spatial Layout). Given an r-rank tensor with shape (n₁, n₂, . . . , nᵣ), define the spatial layout spatial(n₁, n₂, . . . , nᵣ) as a layout that distributes all elements across n₁n₂ . . . nᵣ threads, where each thread holds a single element:

$$f ( t , i ) = t / ( {n}_{2} {n}_{3} … {n}_{r} ) , t / ( {n}_{3} {n}_{4} … {n}_{r} ) \% {n}_{2} , … , t \% {n}_{r} ) .$$

Here, 0≤t<n₁n₂ . . . nᵣ=T and 0≤i<1=m. In code, represent such a layout as spatial(n1, n2, . . . , nr).
Definition 4 (Layout Composition). Given two layouts f and g with the same rank r, define the composition layout h of f and g as:

$$h ( t , i ) = f ( t / {T}_{g} , i / {m}_{g} ) ⊙ {S}_{g} + g ( t \% {T}_{g} , i \% mg ) ,$$

$${T}_{h} = {T}_{f} {T}_{g} ,$$

$${m}_{h} = {m}_{f} {m}_{g} ,$$

$${S}_{h} = {S}_{f} ⊙ {S}_{g} ,$$

where T_{h,f,g}, m_{h,f,g}, and S_{h,f,g} are the number of threads, local elements per thread, and shape of layouts h, f, g, respectively. Here, ⊙ represents elementwise multiplication. The composition is denoted as h=f∘g. In code, use spatial(2, 3).local(3, 2) to denote the composition of spatial(2, 3) and local(3, 2).
Theorem 1 (Layout Composition Associativity). The layout composition operation is associative:

$$f ∘ ( g ∘ h ) = ( f ∘ g ) ∘ h .$$

Proof. Let f, g, h be layouts with the following properties:

$$f ( t , i ) : {N}_{Tf} \times {N}_{mf} \to {N}_{n 1} \times … \times {N}_{n r} ,$$

$$g ( t , i ) : {N}_{Tg} \times {N}_{mg} \to {N}_{n 1} \times … \times {N}_{n r} ,$$

$$h ( t , i ) : {N}_{Th} \times {N}_{mh} \to {N}_{n 1} \times … \times {N}_{n r} .$$

For f∘g, the layout k(t, i) is:

$$k ( t , i ) = f ( t / {T}_{g} , i / {m}_{g} ) ⊙ {S}_{g} + g ( t \% {T}_{g} , i \% {m}_{g} ) ,$$

where Tₖ=T_{f}T_{g}, mₖ=m_{f}m_{g}, Sₖ=S_{f}∘S_{g}.

For g∘h, the layout l(t, i) is:

$$l ( t , i ) = g ( t / {T}_{h} , i / {m}_{h} ) ⊙ {S}_{g} + h ( t \% {T}_{h} , i \% {m}_{h} ) ,$$

where Tₗ=T_{g}Tₕ, mₗ=m_{g}mₕ, Sₗ=S_{g} ∘Sₕ.

Now consider f∘(g∘h), and get layout p:

$$p ( t , i ) = f ( t / {T}_{l} , i / {m}_{l} ) ⊙ {S}_{l} + l ( t \% {T}_{l} , i \% {m}_{l} ) .$$

Expanding/(t % Tₗ, i % mₗ):

$$l ( t \% {T}_{l} , i \% {m}_{l} ) = g ( ( t \% {T}_{l} ) / {T}_{h} , ( i \% {m}_{l} ) / {m}_{h} ) ⊙ {S}_{h} + {}_{⩵} h ( ( t \% {T}_{l} ) \% {T}_{h} , ( i \% {m}_{l} ) \% {m}_{h} ) .$$

Substituting this into p(t, i):

$$ρ ( t , i ) = f ( t / {T}_{l} , i / {m}_{l} ) ⊙ {S}_{l} + g ( ( t \% {T}_{l} ) / {T}_{h} , ( i \% {m}_{l} ) / {m}_{h} ) ⊙ {S}_{h} + h ( ( t \% {T}_{l} ) \% {T}_{h} , ( i \% {m}_{l} ) \% {m}_{h} ) .$$

For (f∘g)∘h, get layout q:

$$q ( t , i ) = k ( t / {T}_{h} , i / {m}_{h} ) ⊙ {S}_{h} + h ( t \% {T}_{h} , i \% {m}_{h} ) .$$

Expanding k(t/Tₕ, i/mₕ)

$$k ( t / {T}_{h} , i / {m}_{h} ) = f ( ( t / {T}_{h} ) / {T}_{g} , ( i / {m}_{h} ) / {m}_{g} ) ⊙ {S}_{g} + g ( ( t / {T}_{h} ) \% {T}_{g} , ( i / {m}_{h} ) \% {m}_{g} ) .$$

Substituting this into q(t, i):

$$q ( t , i ) = f ( t / {T}_{l} , i / {m}_{l} ) ⊙ {S}_{l} + g ( ( t \% {T}_{l} ) / {T}_{h} , ( i \% {m}_{l} ) / {m}_{h} ) ⊙ {S}_{h} + h ( ( t \% {T}_{l} ) \% {T}_{h} , ( i \% {m}_{l} ) \% {m}_{h} ) .$$

Since p(t, i)=q(t, i), conclude:

$$f ∘ ( g ∘ h ) = ( f ∘ g ) ∘ h .$$

This completes the proof.
Definition 5 (Layout Broadcast). To handle layouts of different ranks, define the layout broadcast operation, which increases the rank of a layout by prepending zeros to the output.

Let f(t, i): N_{T}×Nₘ→Nₙ₁× . . . ×Nₙᵣ be a layout of rank r. To broadcast f to rank r′ >r, define:

$${f}^{′} ( t , i ) = ( 0 , … , 0 , f ( t , i ) ) ,$$

where r′−r zeros are prepended. In code, this is denoted as broadcast(f, rank).

Using broadcast, compose any two layouts f and g of ranks r_{f} and r_{g}, respectively, by broadcasting the smaller rank to match the larger one before composition:

$$f ∘ g = broadcast ( f , max ( {r}_{f} , {r}_{g} ) ) ∘ broadcast ( g , max ( {r}_{f} , {r}_{g} ) ) .$$

Definition 6 (Layout Division). Given two layouts f and g, if there exists a layout h such that f=h∘g, define h as the result of dividing f by g:

$$h = f / g .$$

In code, this is denoted as f/g.
Theorem 2 (Monoid Structure of Layouts). The set of layouts L, under the composition operator ∘, forms a monoid.

Proof. To prove that (L, ∘) is a monoid, verify the three properties:
Closure: The composition of two layouts is a layout, as shown in the definition of composition.
Associativity: This was proven earlier in the theorem on layout composition associativity.
Identity Element: Define the identity layout e as repeat(1) (or equivalently spatial(1)). It satisfies f∘e=e∘f=f for any layout f.

Thus, (L, ∘) satisfies the monoid properties.

### Optimized Matrix Multiplication

In FIGS. 4A to 4C, an example of quantized matrix multiplication (FP16×INT6) is presented. This example primarily demonstrates the programming of the VM 12 using algebraic layouts, thread-block-level instructions, and the handling of low-precision data types.

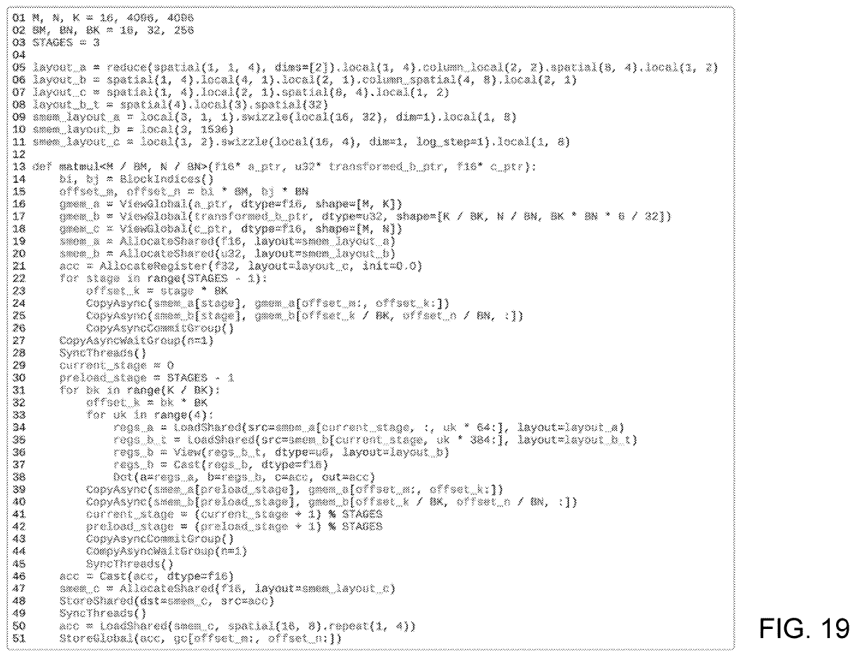

In this section, the example from above is extended by introducing software pipelining and selecting better tiling sizes to program an efficient matrix multiplication. The complete example program is illustrated in FIG. 19.

In this program shown in FIG. 19, compared to the simplified version in FIGS. 4A-4C is the use of shared memory to store global sub-tensors, which can significantly enhance data reuse since shared memory is an order of magnitude faster than global memory [29]. Shared memory is also employed as a staging area for results before writing them back to global memory, ensuring coalesced global memory access [29]. Asynchronous data transfer from global memory to shared memory is achieved using the CopyAsync, CopyAsyncCommitGroup, and CopyAsyncWaitGroup instructions. To maximize performance, memory loading is pipelined with computation. This is accomplished by allocating three shared memory buffers for each operand (A and B). During the main loop (Line 31-45), the shared memory buffer for the next stage (preload_stage) is populated (Line 39-40) while computations are performed using the buffer for the current stage (current stage). These optimizations are essential to achieve state-of-the-art performance. The VM 12 may not only support these optimizations seamlessly but can also accommodate arbitrary low-bit-width quantized data types via register tensor reinterpretation (Line 36).

The example program code shown in FIG. 19 includes a number of lines of codes that are explained below:

Initialization: Workload sizes, tiling sizes, and the number of pipeline stages are defined (Line 1-3). Register and shared memory tensor layouts for the virtual machine program are then specified (Line 5-11). There are two new operations over the layouts that were not introduced in the main text: reduce( . . . ) and swizzle( . . . ). The reduce( . . . ) layout reduces a layout over some dimensions. If there are multiple indices over that dimension are stored in the same thread, the thread will only keep one copy of the elements. If there are multiple threads along the reduction dimension, we will retain one copy of the element for each thread.

In this example, reduce(spatial(1, 1, 4), dims=[2]) is a layout with shape (1,1) and 4 threads. Each thread will hold the element (0,0). On the other hand, the swizzle operator swizzle a layout by performing the following operation:

$$swizzle ( i , j ) = ( i , j ⊕ ⌊ \frac{i}{{2}^{log\_step}} ⌋ )$$

$$g ( t , i ) = swizzle ( f ( t , i ) )$$

where ⊕ is bitwise-xor operation, and log_step is the parameter of the swizzle operator. The dim=1 in the code indicates that we hope to swizzle the dimension 1, that is why the dimension was changed to 1 and the other dimension kept unchanged. The swizzle operation is used to avoid the shared memory bank-conflict [29] for both the global to shared memory transfer (via CopyAsync) and the shared memory to register transfer (via LoadShared).

Global Tensor Views and Memory Allocation: Global tensor views and offsets for thread blocks are initialized (Line 14-18). Shared memory for software pipelining and registers for accumulation are allocated (Line 19-21).

Preloading Shared Memory: The first STAGES—1 iterations of the main loop preload shared memory buffers (Line 22-28). Two variables, current_stage and preload_stage, track the buffers used for computation and memory copying (Line 29, 30).

Main Loop: For each iteration, the k-dimension is further tiled to reduce register usage (Line 33-38). Shared memory buffers are loaded into register tensors, reinterpreted for quantized data types, and cast to the computation data type (e.g., FP16). The dot product operation is then performed. Simultaneously, asynchronous globalto-shared memory transfers are issued using a separate buffer (Line 39-44). This multi-buffer approach enables parallel utilization of GPU computation and memory transfer units.

Result Storing: After completing the main loop, the accumulation tensor is cast from float32 to float16 (Line 46). The tensor is stored in shared memory (Line 48), reloaded into a new register tensor (Line 50), and written back to global memory with coalesced access (Line 51). This improved program illustrates the flexibility of the virtual machine in implementing advanced optimizations while supporting low-precision data types efficiently. By utilizing shared memory, asynchronous transfers, and software pipelining, it achieves significant performance gains.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

### REFERENCES

[1] Tor M Aamodt, Wilson Wai Lun Fung, and Timothy G Rogers. The simt core: Instruction and register data flow. In General-Purpose Graphics Processor Architectures, pages 21-66. Springer, 2018.
[2] Andrew Adams, Karima Ma, Luke Anderson, Riyadh Baghdadi, Tzu-Mao Li, Michael Gharbi, Benoit Steiner, Steven Johnson, Kayvon Fatahalian, Fredo Durand, and Jonathan Ragan-Kelley. Learning to optimize halide with tree search and random programs. ACM Trans. Graph., 38(4), July 2019.
[3] AMD Corporation. CDNA 3 Architecture for Accelerated Computing, 2024. Available at https://www.amd.com/en/technologies/cdna.html.
[4] AMD Corporation. HIP: Heterogeneous-Compute Interface for Portability, 2024. Available at https://rocm.docs.amd.com/projects/HIP/en/latest/.
[5] AMD Corporation. RDNA 3 Graphics Architecture Overview, 2024. Available at https://www.amd.com/en/technologies/rdna.html.
[6] Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, Sandhini Agarwal, Ariel Herbert-Voss, Gretchen Krueger, Tom Henighan, Rewon Child, Aditya Ramesh, Daniel Ziegler, Jeffrey Wu, Clemens Winter, Chris Hesse, Mark Chen, Eric Sigler, Mateusz Litwin, Scott Gray, Benjamin Chess, Jack Clark, Christopher Berner, Sam McCandlish, Alec Radford, Ilya Sutskever, and Dario Amodei. Language models are few-shot learners. In H. Larochelle, M. Ranzato, R. Hadsell, M. F. Balcan, and H. Lin, editors, Advances in Neural Information Processing Systems, volume 33, pages 1877-1901. Curran Associates, Inc., 2020.
[7] Tianqi Chen, Thierry Moreau, Ziheng Jiang, Lianmin Zheng, Eddie Q. Yan, Haichen Shen, Meghan Cowan, Leyuan Wang, Yuwei Hu, Luis Ceze, Carlos Guestrin, and Arvind Krishnamurthy. Tvm: An automated end-to-end optimizing compiler for deep learning. In OSDI, 2018.
[8] Tri Dao, Dan Fu, Stefano Ermon, Atri Rudra, and Christopher Re. Flashattention: Fast and memory-efficient exact attention with io-awareness. In S. Koyejo, S. Mohamed, A. Agarwal, D. Belgrave, K. Cho, and A. Oh, editors, Advances in Neural Information Processing Systems, volume 35, pages 16344-16359. Curran Associates, Inc., 2022.
[9] Tim Dettmers, Mike Lewis, Younes Belkada, and Luke Zettlemoyer. Llm.int8( ): 8-bit matrix multiplication for transformers at scale. In Proceedings of the 36th International Conference on Neural Information Processing Systems, NIPS '22, Red Hook, NY, USA, 2024. Curran Associates Inc.
[10] Yaoyao Ding, Cody Hao Yu, Bojian Zheng, Yizhi Liu, Yida Wang, and Gennady Pekhimenko. Hidet: Task-mapping programming paradigm for deep learning tensor programs. In Proceedings of the 28th ACM International Conference on Architectural Support for Programming Languages and Operating Systems, Volume 2, ASPLOS 2023, page 370-384, New York, NY, USA, 2023. Association for Computing Machinery.
[11] Yaoyao Ding, Ligeng Zhu, Zhihao Jia, Gennady Pekhimenko, and Song Han. Ios: Inter-operator scheduler for cnn acceleration. Proceedings of Machine Learning and Systems, 3:167-180, 2021.
[12] Pratik Fegade, Tianqi Chen, Phillip Gibbons, and Todd Mowry. Cortex: A compiler for recursive deep learning models. Proceedings of Machine Learning and Systems, 3:38-54, 2021.
[13] Pratik Fegade, Tianqi Chen, Phillip Gibbons, and Todd Mowry. The cora tensor compiler: Compilation for ragged tensors with minimal padding. In D. Marculescu, Y. Chi, and C. Wu, editors, Proceedings of Machine Learning and Systems, volume 4, pages 721-747, 2022.
[14] Siyuan Feng, Bohan Hou, Hongyi Jin, Wuwei Lin, Junru Shao, Ruihang Lai, Zihao Ye, Lianmin Zheng, Cody Hao Yu, Yong Yu, and Tianqi Chen. Tensorir: An abstraction for automatic tensorized program optimization. In Proceedings of the 28^{th} ACM International Conference on Architectural Support for Programming Languages and Operating Systems, Volume 2, ASPLOS 2023, page 804-817, New York, NY, USA, 2023. Association for Computing Machinery.
[15] Elias Frantar, Saleh Ashkboos, Torsten Hoefler, and Dan Alistarh. Gptq: Accurate post-training quantization for generative pre-trained transformers. arXiv preprint arXiv:2210.17323, 2022.
[16] Bastian Hagedorn, Bin Fan, Hanfeng Chen, Cris Cecka, Michael Garland, and Vinod Grover. Graphene: An ir for optimized tensor computations on gpus. In Proceedings of the 28th ACM International Conference on Architectural Support for Programming Languages and Operating Systems, Volume 3, ASPLOS 2023, page 302-313, New York, NY, USA, 2023. Association for Computing Machinery.
[17] Adnan Hoque, Less Wright, Chih-Chieh Yang, Mudhakar Srivatsa, and Raghu Ganti. Accelerating a triton fused kernel for w4a16 quantized inference with splitk work decomposition. arXiv preprint arXiv:2402.00025, 2024.
[18] Guyue Huang, Yang Bai, Liu Liu, Yuke Wang, Bei Yu, Yufei Ding, and Yuan Xie. Alcop: Automatic load-compute pipelining in deep learning compiler for ai-gpus. Proceedings of Machine Learning and Systems, 5:680-694, 2023.
[19] IEEE Standards Association. IEEE Standard for Floating-Point Arithmetic (IEEE 754-2019). IEEE, New York, NY, 2019. Available at https://standards.ieee.org/standard/754-2019.html.
[20] Zhihao Jia, Oded Padon, James Thomas, Todd Warszawski, Matei Zaharia, and Alex Aiken. Taso: optimizing deep learning computation with automatic generation of graph substitutions. In Proceedings of the 27th ACM Symposium on Operating Systems Principles, pages 47-62, 2019.
[21] Woosuk Kwon, Zhuohan Li, Siyuan Zhuang, Ying Sheng, Lianmin Zheng, Cody Hao Yu, Joseph E. Gonzalez, Hao Zhang, and Ion Stoica. Efficient memory management for large language model serving with pagedattention. In Proceedings of the ACM SIGOPS 29th Symposium on Operating Systems Principles, 2023. [22] Chris Lattner, Mehdi Amini, Uday Bondhugula, Albert Cohen, Andy Davis, Jacques Pienaar, River Riddle, Tatiana Shpeisman, Nicolas Vasilache, and Oleksandr Zinenko. Mlir: scaling compiler infrastructure for domain specific computation. In Proceedings of the 2021 IEEE/ACM International Symposium on Code Generation and Optimization, CGO '21, page 2-14. IEEE Press, 2021.
[23] Ji Lin, Jiaming Tang, Haotian Tang, Shang Yang, Wei-Ming Chen, Wei-Chen Wang, Guangxuan Xiao, Xingyu Dang, Chuang Gan, and Song Han. Awq: Activation-aware weight quantization for Ilm compression and acceleration. In MLSys, 2024.
[24] Yang Liu and Mirella Lapata. Text summarization with pretrained encoders. In Kentaro Inui, Jing Jiang, Vincent Ng, and Xiaojun Wan, editors, Proceedings of the 2019 Conference on Empirical Methods in Natural Language Processing and the 9th International Joint Conference on Natural Language Processing (EMNLP-IJCNLP), pages 3730-3740, Hong Kong, China, November 2019. Association for Computational Linguistics.
[25] Lingxiao Ma, Zhiqiang Xie, Zhi Yang, Jilong Xue, Youshan Miao, Wei Cui, Wenxiang Hu, Fan Yang, Lintao Zhang, and Lidong Zhou. RAMMER: Enabling Holistic Deep Learning Compiler Optimizations with Rtasks, page 17. USENIX Association, USA, 2020.
[26] John Nickolls and William J. Dally. The gpu computing era. IEEE Micro, 30(2):56-69, 2010.
[27] NVIDIA Corporation. Cutlass: Cuda templates for linear algebra subroutines and solvers. https://github.com/NVIDIA/cutlass, 2021.
[28] NVIDIA Corporation. NVIDIA cuBLAS Library, 2023. Version 12.2.
[29] NVIDIA Corporation. CUDA C++ Programming Guide, 2024. Version 12.0. Available at https://docs.nvidia.com/cuda/cuda-c-programming-guide/.
[30] NVIDIA Corporation. Parallel Thread Execution ISA Version 12.0, 2024. Available at https://docs.nvidia.com/cuda/parallel-thread-execution/index.html.
[31] NVIDIA Corporation. SASS: Streaming Assembler for NVIDIA GPUs, 2024. Available at https://docs.nvidia.com/cuda/cuda-binary-utilities/index.html.
[32] OpenAI. ChatGPT. https://chat.openai.com/, 2024. Accessed: 2024-11-12; Generative AI language model.
[33] Muhammad Osama, Duane Merrill, Cris Cecka, Michael Garland, and John D. Owens. Stream-k: Work-centric parallel decomposition for dense matrix-matrix multiplication on the gpu. In Proceedings of the 28th ACM SIGPLAN Annual Symposium on Principles and Practice of Parallel Programming, PPoPP '23, page 429-431, New York, NY, USA, 2023. Association for Computing Machinery.
[34] Jonathan Ragan-Kelley, Connelly Barnes, Andrew Adams, Sylvain Paris, Fredo Durand, and Saman Amarasinghe. Halide: a language and compiler for optimizing parallelism, locality, and recomputation in image processing pipelines. In Acm Sigplan Notices, volume 48, pages 519-530. ACM, 2013.
[35] Amit Sabne. Xla: Compiling machine learning for peak performance, 2020.
[36] Junru Shao, Xiyou Zhou, Siyuan Feng, Bohan Hou, Ruihang Lai, Hongyi Jin, Wuwei Lin, Masahiro Masuda, Cody Hao Yu, and Tianqi Chen. Tensor program optimization with probabilistic programs. In Proceedings of the 36th International Conference on Neural Information Processing Systems, NIPS '22, Red Hook, NY, USA, 2024. Curran Associates Inc.
[37] Haichen Shen, Jared Roesch, Zhi Chen, Wei Chen, Yong Wu, Mu Li, Vin Sharma, Zachary Tatlock, and Yida Wang. Nimble: Efficiently compiling dynamic neural networks for model inference. In A. Smola, A. Dimakis, and I. Stoica, editors, Proceedings of Machine Learning and Systems, volume 3, pages 208-222, 2021.
[38] Shizhi Tang, Jidong Zhai, Haojie Wang, Lin Jiang, Liyan Zheng, Zhenhao Yuan, and Chen Zhang. Freetensor: A freeform dsl with holistic optimizations for irregular tensor programs. In Proceedings of the 43rd ACM SIGPLAN International Conference on Programming Language Design and Implementation (PLDI '22), PLDI '22, New York, NY, USA, 2022.
[39] Gemma Team, Morgane Riviere, Shreya Pathak, Pier Giuseppe Sessa, Cassidy Hardin, Surya Bhupatiraju, Leonard Hussenot, Thomas Mesnard, Bobak Shahriari, Alexandre Rame, et al. Gemma 2: Improving open language models at a practical size. arXiv preprint arXiv:2408.00118, 2024.
[40] The Khronos Group. OpenCL Specification Version 3.0, 2024. Available at https://registry.khronos.org/OpenCL/.
[41] Philippe Tillet, H. T. Kung, and David Cox. Triton: an intermediate language and compiler for tiled neural network computations. In Proceedings of the 3rd ACM SIGPLAN International Workshop on Machine Learning and Programming Languages, MAPL 2019, page 10-19, New York, NY, USA, 2019. Association for Computing Machinery.
[42]R. M. Tomasulo. An efficient algorithm for exploiting multiple arithmetic units. IBM J. Res. Dev., 11(1):25-33, January 1967.
[43] Hugo Touvron, Thibaut Lavril, Gautier Izacard, Xavier Martinet, Marie-Anne Lachaux, Timothee Lacroix, Baptiste Roziere, Naman Goyal, Eric Hambro, Faisal Azhar, et al. Llama: Open and efficient foundation language models. arXiv preprint arXiv:2302.13971, 2023.
[44] Nicolas Vasilache, Oleksandr Zinenko, Theodoros Theodoridis, Priya Goyal, Zach DeVito, William S. Moses, Sven Verdoolaege, Andrew Adams, and Albert Cohen. Tensor comprehensions: Framework-agnostic high-performance machine learning abstractions. ArXiv, abs/1802.04730, 2018.
[45] Ashish Vaswani, Noam Shazeer, Niki Parmar, Jakob Uszkoreit, Llion Jones, Aidan N Gomez, Łukasz Kaiser, and Illia Polosukhin. Attention is all you need. In I. Guyon, U. Von Luxburg, S. Bengio, H. Wallach, R. Fergus, S. Vishwanathan, and R. Garnett, editors, Advances in Neural Information Processing Systems, volume 30. Curran Associates, Inc., 2017.
[46] Ashish Vaswani, Noam Shazeer, Niki Parmar, Jakob Uszkoreit, Llion Jones, Aidan N Gomez, Łukasz Kaiser, and Illia Polosukhin. Attention is all you need. In I. Guyon, U. Von Luxburg, S. Bengio, H. Wallach, R. Fergus, S. Vishwanathan, and R. Garnett, editors, Advances in Neural Information Processing Systems, volume 30. Curran Associates, Inc., 2017.
[47] LeiWang, Lingxiao Ma, Shijie Cao, Quanlu Zhang, Jilong Xue, Yining Shi, Ningxin Zheng, Ziming Miao, Fan Yang, Ting Cao, Yuqing Yang, and Mao Yang. Ladder: Enabling efficient Low-Precision deep learning computing through hardware-aware tensor transformation. In 18th USENIX Symposium on Operating Systems Design and Implementation (OSDI 24), pages 307-323, Santa Clara, CA, July 2024. USENIX Association.
[48] JianWeng, Animesh Jain, JieWang, LeyuanWang, YidaWang, and Tony Nowatzki. UNIT: Unifying Tensorized Instruction Compilation, page 77-89. IEEE Press, 2021.
[49] BigScience Workshop, Teven Le Scao, Angela Fan, Christopher Akiki, Ellie Pavlick, Suzana Ili'c, Daniel Hesslow, Roman Castagne, Alexandra Sasha Luccioni, Francois Yvon, et al. Bloom: A 176b-parameter open-access multilingual language model. arXiv preprint arXiv:2211.05100, 2022.
[50] Haojun Xia, Zhen Zheng, Xiaoxia Wu, Shiyang Chen, Zhewei Yao, Stephen Youn, Arash Bakhtiari, Michael Wyatt, Donglin Zhuang, Zhongzhu Zhou, Olatunji Ruwase, Yuxiong He, and Shuaiwen Leon Song. Quant-LLM: Accelerating the serving of large language models via FP6-Centric Algorithm-System Co-Design on modern GPUs. In 2024 USENIX Annual Technical Conference (USENIX ATC 24), pages 699-713, Santa Clara, CA, July 2024. USENIX Association.
[51] Jiarong Xing, Leyuan Wang, Shang Zhang, Jack Chen, Ang Chen, and Yibo Zhu. Bolt: Bridging the gap between autotuners and hardware-native performance. In Proceedings of Machine Learning and Systems, volume 4, 2022.
[52] An Yang, Baosong Yang, Binyuan Hui, Bo Zheng, Bowen Yu, Chang Zhou, Chengpeng Li, Chengyuan Li, Dayiheng Liu, Fei Huang, et al. Qwen2 technical report. arXiv preprint arXiv:2407.10671, 2024.
[53] Gyeong-In Yu, Joo Seong Jeong, Geon-Woo Kim, Soojeong Kim, and Byung-Gon Chun. Orca: A distributed serving system for Transformer-Based generative models. In 16^{th} USENIX Symposium on Operating Systems Design and Implementation (OSDI 22), pages 521-538, Carlsbad, CA, July 2022. USENIX Association.
[54] Jie Zhao, Xiong Gao, Ruijie Xia, Zhaochuang Zhang, Deshi Chen, Lei Chen, Renwei Zhang, Zhen Geng, Bin Cheng, and Xuefeng Jin. Apollo: Automatic partition-based operator fusion through layer by layer optimization. In D. Marculescu, Y. Chi, and C. Wu, editors, Proceedings of Machine Learning and Systems, volume 4, pages 1-19, 2022.
[55] Bojian Zheng, Ziheng Jiang, Cody Hao Yu, Haichen Shen, Joshua Fromm, Yizhi Liu, YidaWang, Luis Ceze, Tianqi Chen, and Gennady Pekhimenko. DietCode: Automatic optimization for dynamic tensor programs. In D. Marculescu, Y. Chi, and C. Wu, editors, Proceedings of Machine Learning and Systems, volume 4, pages 848-863, 2022.
[56] Lianmin Zheng, Chengfan Jia, Minmin Sun, Zhao Wu, Cody Hao Yu, Ameer Haj-Ali, Yida Wang, Jun Yang, Danyang Zhuo, Koushik Sen, Joseph E. Gonzalez, and Ion Stoica. Ansor: Generating high-performance tensor programs for deep learning. In 14th USENIX Symposium on Operating Systems Design and Implementation (OSDI 20), pages 863-879, 2020.
[57] Size Zheng, Renze Chen, Anjiang Wei, Yicheng Jin, Qin Han, Liqiang Lu, Bingyang Wu, Xiuhong Li, Shengen Yan, and Yun Liang. Amos: enabling <u>a</u>utomatic <u>m</u>apping for tensor computations <u>o</u>n<u>s</u>patial accelerators with hardware abstraction. In Proceedings of the 49^{th} Annual International Symposium on Computer Architecture, ISCA '22, page 874-887, New York, NY, USA, 2022. Association for Computing Machinery.
[58] Size Zheng, Yun Liang, Shuo Wang, Renze Chen, and Kaiwen Sheng. Flextensor: An automatic schedule exploration and optimization framework for tensor computation on heterogeneous system. Proceedings of the Twenty-Fifth International Conference on Architectural Support for Programming Languages and Operating Systems, 2020.
[59] Zhen Zheng, Xuanda Yang, Pengzhan Zhao, Guoping Long, Kai Zhu, Feiwen Zhu, Wenyi Zhao, Xiaoyong Liu, Jun Yang, Jidong Zhai, Shuaiwen Leon Song, and Wei Lin. Astitch: Enabling a new multi-dimensional optimization space for memory-intensive ml training and inference on modern simt architectures. In Proceedings of the 27th ACM International Conference on Architectural Support for Programming Languages and Operating Systems, ASPLOS '22, page 359-373, New York, NY, USA, 2022. Association for Computing Machinery.
[60] Hongyu Zhu, Ruofan Wu, Yijia Diao, Shanbin Ke, Haoyu Li, Chen Zhang, Jilong Xue, Lingxiao Ma, Yuqing Xia, Wei Cui, Fan Yang, Mao Yang, Lidong Zhou, Asaf Cidon, and Gennady Pekhimenko. ROLLER: Fast and efficient tensor compilation for deep learning. In 16th USENIX Symposium on Operating Systems Design and Implementation (OSDI 22), pages 233-248, Carlsbad, CA, July 2022. USENIX Association.
[61]K. Zhu, W. Y. Zhao, Z. Zheng, T. Y. Guo, P. Z. Zhao, J. J. Bai, J. Yang, X. Y. Liu, L. S. Diao, and W. Lin. Disc: A dynamic shape compiler for machine learning workloads. In Proceedings of the 1st Workshop on Machine Learning and Systems, EuroMLSys '21, page 89-95, New York, NY, USA, 2021. Association for Computing Machinery.

1. A method for executing computational workloads on a computational processing unit, the method comprising:
deploying a virtual machine (VM) by:
abstracting program behavior of the computational processing unit into instructions associated with groups of execution threads;
providing a data layout system defining distribution of data elements across threads within the groups of execution threads; and
executing computational workloads by processing data elements distributed according to the data layout system.

2. The method as claimed in claim 1, wherein the computational workload comprises one or more of a large language model (LLM) inference or LLM serving or at least one general machine learning workload.

3. The method as claimed in claim 1, wherein executing the computational workloads further comprises automatic vectorization of the processed data elements.

4. The method as claimed in claim 1 further comprising enabling access to memory spaces associated with the computational processing unit to enable memory control for executing computational workloads.

5. The method as claimed in claim 4, wherein enabling access to memory spaces further comprises defining a mapping between a logical index of a data element and a location of the corresponding data element within one or more memory scopes of the memory spaces.

6. The method as claimed in claim 1, wherein executing computational workloads includes reinterpreting the data elements distributed according to the data layout system into a data type different from an original data type of the data elements.

7. The method as claimed in claim 1, wherein the computational processing unit is a graphics processing unit (GPU) and the groups of execution threads correspond to thread-blocks associated with the GPU, and wherein the program behavior of the GPU is abstracted into a thread-block-level instructions model.

8. The method as claimed in claim 1, wherein the data layout system is an algebraic layout system.

9. The method as claimed in claim 1, wherein the data elements are represented using variable bit widths.

10. The method as claimed in claim 9, wherein the data elements are represented using arbitrary low-precision bit widths ranging from 1 to 8 bit widths.

11. The method as claimed in claim 1, wherein the data elements include signed integer, unsigned integer and floating point data types.

12. A computer readable medium storing computer-executable instructions for performing the method as claimed in claim 1.

13. A system for executing computational workloads on a computational processing unit, the system comprising a processor configured to:
deploy a virtual machine (VM) by:
abstracting program behavior of the computational processing unit into instructions associated with groups of execution threads;
providing a data layout system defining distribution of data elements across threads within the groups of execution threads; and
execute computational workloads by processing data elements distributed according to the data layout system.

14. The system as claimed in claim 13, wherein the computational processing unit includes one or more graphics processing units (GPUs) and the groups of execution threads correspond to thread-blocks associated with the GPUs, and wherein the program behavior of the GPU is abstracted into a thread-block-level instructions model.

15. The system as claimed in claim 13, wherein the computational workload comprises one or more of large language model (LLM) inference or LLM serving or at least one general machine learning workload.

16. The system as claimed in claim 13, wherein the processor is further configured to perform automatic vectorization of the processed data elements.

17. The system as claimed in claim 13, wherein the processor is further configured to enable access to memory spaces associated with the computational processing unit by defining a mapping between a logical index of a data element and a location of the corresponding data element within one or more memory scopes of the memory spaces.

18. The system as claimed in claim 13, wherein the processor is further configured to reinterpret the data elements distributed according to the data layout system into a data type different from an original data type of the data elements.

19. The system as claimed in claim 13, wherein the data layout system is an algebraic layout system.

20. The system as claimed in claim 13, wherein the data elements are represented using variable bit widths including arbitrary low-precision bit widths ranging from 1 to 8 bit widths.
